(19) United States
(12) Patent Application Publication
(10) Pub. No.: US 2011/0113338 A1
(43) Pub. Date: May 12, 2011

(54) Information output apparatus and method and program

(75) Inventors: Makoto Aoki, Tokyo (JP); Eiju Yamada, Kanagawa (JP); Akihiko Kinoshita, Tokyo (JP)

(73) Assignee: Sony Corporation, Tokyo (JP)

(21) Appl. No.: 12/925,286

(22) Filed: Oct. 18, 2010

(30) Foreign Application Priority Data
Nov. 9, 2009 (JP) P2009-255955

(51) Int. Cl. G06F 3/00

(52) U.S. Cl. 715/730

(57) ABSTRACT

Disclosed herein is an information output apparatus including: a storage configured to store an output sequence of content; an output controller configured to control output of the content; and an acquirer configured to obtain output information of the content to be added, wherein the acquirer obtains the content and an output condition as the output information of the content to be added from a terminal apparatus, the storage stores the sequence of the content to be added, and the output controller outputs the content to be added in the stored sequence in accordance with the output condition.

### BACKGROUND OF THE INVENTION

1. Field of the Invention

The present invention relates to an information apparatus and method and a program and, more particularly, to an information output apparatus and method and a program that are configured to add content during outputting of content.

2. Description of the Related Art

Viewing slide shows on a large-size screen of a television receiver for example requires each user to create slide shows in advance. It is proposed that content to be displayed in slide shows be obtained from two or more devices.

For example, Japanese Patent Laid-open No. 2008-16930 (hereinafter referred to as Patent Document 1) discloses a system in which two or more devices are connected and images stored in these connected devices are collectively reproduced in slide show, shuffle, and random manners.

### SUMMARY OF THE INVENTION

It should be noted however that the technique disclosed in Patent Document 1 above is intended to reproduce images from two or more devices and the images to be reproduced are limited to those obtained by user beforehand.

Another problem with the above-mentioned disclosed technique is that only those users who created slide shows can participate in the creation of slide shows and therefore, the users who created slide shows and other users cannot add new content while a slide show is being executed.

Therefore, the present invention addresses the above-identified and other problems associated with related-art methods and apparatuses and solves the addressed problems by providing an information output apparatus and method and a program that are configured to allow the addition of content during a content output operation.

In carrying out the invention and according to one embodiment thereof, there is provided an information output apparatus, an information output method, or a program for making a computer function as the information output apparatus. This information output apparatus has storage means for storing an output sequence of content; output control means for controlling output of the content; and acquisition means for obtaining output information of the content to be added. In this information output apparatus, the acquisition means obtains the content and an output condition as the output information of the content to be added from a terminal apparatus, the storage means stores the sequence of the content to be added, and the output control means outputs the content to be added in the stored sequence in accordance with the output condition.

In the above-mentioned information output apparatus, the output condition includes an output priority of the content and the output control means preferentially outputs the prioritized content and, if there is no content to be prioritized, outputs the content in a sequence of storage.

In the above-mentioned information output apparatus, the output condition includes a position at which the content is outputted, a size in which the content is outputted, and a time at which the content is outputted. If no output condition is set to the content, an output condition preset to the information output apparatus is used.

In the above-mentioned information output apparatus, the acquisition means obtains the user information of the terminal apparatus. The information output apparatus further has decision means for deciding on the basis of the user information whether the content being outputted is convertible on the terminal apparatus.

In the above-mentioned information output apparatus, when the acquisition means has acquired a request to obtain the content being outputted from the terminal apparatus, if the decision means decides that the content being outputted is convertible on the terminal apparatus, the acquisition means obtains a URI (Uniform Resource Identifier) of the content being outputted. The information output apparatus still further has transmission means for transmitting the URI of the content being outputted to the terminal apparatus.

In the above-mentioned information output apparatus, if, when a request to obtain the content being outputted has been acquired from the terminal apparatus by the acquisition means, the content being outputted is found by the decision means to be inconvertible on the terminal apparatus, the acquisition means obtains the URI of the content being outputted and installer information of a codec of the content being outputted and the transmission means transmits the URI and the installer information to the terminal apparatus.

In the above-mentioned information output apparatus, if, when a request to obtain the content being outputted has been acquired from the terminal apparatus by the acquisition means, the content being outputted is found by the decision means to be inconvertible on the terminal apparatus, the acquisition means obtains a codec for converting the content being outputted and the codec converts the content being outputted. The information output apparatus yet further has transmission means for transmitting the converted content to the terminal apparatus.

In the above-mentioned information output apparatus, the acquisition means further obtains information related with the content and, on the basis of the user information of the terminal apparatus and the information related with the content, obtains the content that is different for each of the terminal apparatus, and the transmission means transmits the content acquired by the acquisition means that is different for each of the terminal apparatus to the each of the terminal apparatus.

In the above-mentioned information output apparatus, the acquisition means obtains information of the content that a user intends to obtain from the terminal apparatus and the transmission means transmits the content that the user intends to obtain that is different from the content with output thereof controlled by the output control means to the terminal apparatus.

In the above-mentioned information output apparatus, the transmission means transmits the content to the terminal apparatus so as to satisfy the output condition.

In one embodiment of the present invention, an output sequence of content is stored, output of the content is controlled, output information of content to be added is obtained, the content and an output condition are obtained as the output information of the content to be added from the terminal apparatus, a sequence of the content to be added is stored, and the content to be added is outputted in accordance with the stored sequence under the output condition.

According to embodiments of the present invention, a piece of content can be added to another piece of content while the latter content is being outputted.

### BRIEF DESCRIPTION OF THE DRAWINGS

Other features and advantages of the invention will become apparent from the following description of embodiments with reference to the accompanying drawings in which:

FIG. 1 is a schematic diagram illustrating an exemplary configuration of an information output system practiced as one embodiment of the invention;

FIG. 2 is a block diagram illustrating an exemplary configuration of a host apparatus of the above-mentioned information output system;

FIG. 3 is a block diagram illustrating an exemplary configuration of a user terminal apparatus of the above-mentioned information output system;

FIG. 4 is a schematic diagram illustrating an outline of content addition processing and content acquisition processing;

FIG. 5 is a flowchart indicative of content addition processing of the host apparatus and the user terminal apparatus;

FIG. 6 is a diagram illustrating an example of content to be outputted;

FIG. 7 is a flowchart indicative of content addition processing of the host apparatus;

FIG. 8 is a flowchart indicative of content display processing of the host apparatus;

FIG. 9 is a diagram illustrating an example of an output image;

FIG. 10 is a flowchart indicative of content addition processing of the host apparatus;

FIGS. 11A to 11C are diagrams illustrating an outline of content addition processing;

FIG. 12 is a flowchart indicative of content display processing of the host apparatus;

FIG. 13 is a flowchart indicative of music content reproduction processing of the host apparatus;

FIG. 14 is a diagram illustrating an example of an output image;

FIG. 15 is a flowchart indicative of content acquisition processing of the host apparatus and the user terminal apparatus;

FIG. 16 is another flowchart indicative of content acquisition processing of the host apparatus and the user terminal apparatus;

FIG. 17 is a flowchart indicative of content providing processing of the host apparatus;

FIG. 18 is a flowchart indicative of content acquisition processing of the host apparatus and the user terminal apparatus;

FIG. 19 is a flowchart indicative of content providing processing of the host apparatus;

FIG. 20 is a diagram illustrating an outline of content acquisition processing;

FIG. 21 is a diagram illustrating processing to be executed between the host apparatus and a database;

FIG. 22 is a flowchart indicative of music providing processing of the host apparatus;

FIG. 23 is a diagram illustrating an outline of music change processing of the host apparatus;

FIG. 24 is a flowchart indicative of music specification processing of the host apparatus and the user terminal apparatus;

FIG. 25 is a flowchart indicative of specified music reproduction processing of the user terminal apparatus;

FIG. 26 is a flowchart indicative of output content change processing of the host apparatus;

FIG. 27 is a diagram illustrating content to be outputted;

FIG. 28 is a flowchart indicative of output content change processing of the host apparatus;

FIG. 29 is a diagram illustrating an example of content to be outputted; and

FIG. 30 is a block diagram illustrating an exemplary configuration of hardware of a computer to which an embodiment of the present invention is applied.

### DETAILED DESCRIPTION OF THE PREFERRED EMBODIMENTS

This invention will be described in further detail by way of embodiments thereof with reference to the accompanying drawings.

### [Configuration of an Information Output System]

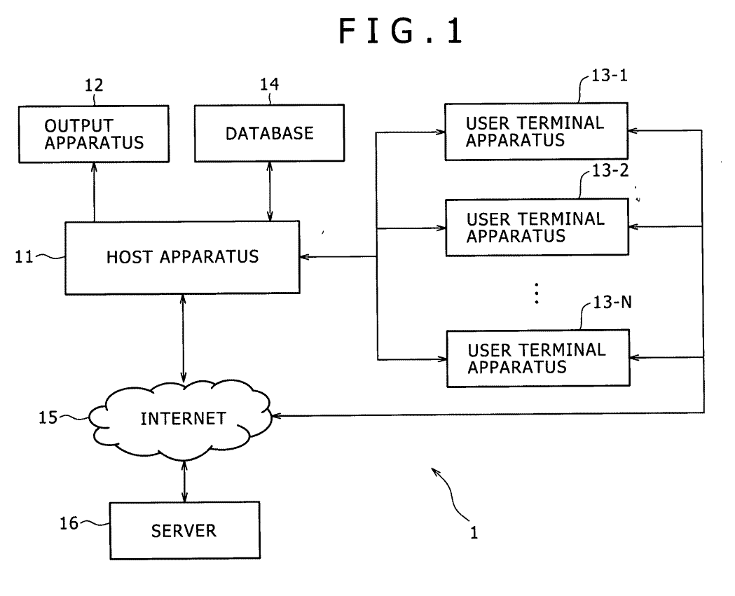

Now, referring to FIG. 1, there is shown an exemplary configuration of an information output system 1 practiced as one embodiment of the present invention.

The information output system 1 shown in FIG. 1 has a host apparatus 11, an output apparatus 12, a user terminal apparatus 13-1 through 13-N (N being 1 or more integer), a database 14, the Internet 15, and a server 16. It should be noted that the user terminal apparatuses 13-1 through 13-N will be generically referred to as the user terminal apparatus unless it is necessary to make distinction between individual apparatuses.

Between the host apparatus 11 and the user terminal apparatus 13 and between the user terminal apparatuses 13, information is transmitted and received via a wireless or wired LAN (Local Area Network) or Bluetooth, for example.

The host apparatus 11 and the user terminal apparatus 13 transmit and receive information to and from the server 16 via the Internet 15.

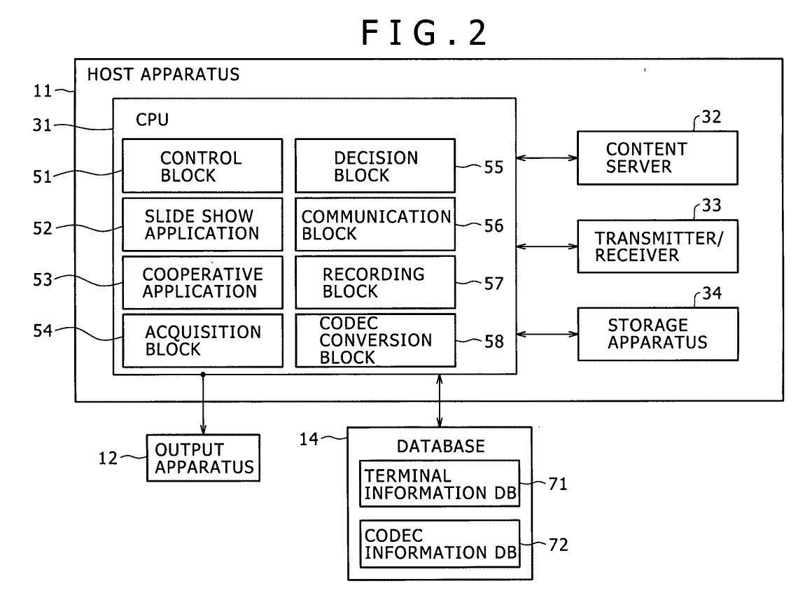

Referring to FIG. 2, there is shown a block diagram illustrating an exemplary configuration of the host apparatus 11 of the information output system 1 shown in FIG. 1.

In the example shown in FIG. 2, the host apparatus 11 has a CPU (Central Processing Unit) 31, a content server 32, a transmitter/receiver 33, and a storage apparatus 34. The CPU 31 has function blocks of a control block 51, a slide show application 52, a cooperative application 53, an acquisition block 54, a decision block 55, a communication block 56, a recording block 57, and a codec conversion block 58. It should be noted that these functional blocks of the CPU 31 are capable of transferring signals (or data) in between as required.

In the present embodiment, the database 14 is arranged external to the host apparatus 11; however, the database 14 may be arranged inside the host apparatus 11.

The control block 51 of the CPU 31 executes processing such as starting up the slide show application 52 and the cooperative application 53. The cooperative application 53 as output control means controls the output of content to be outputted to the output apparatus 12. The cooperative application 53 as transmission means establishes connection with a cooperative application 112 of the user terminal apparatus 13 and transmits content and content-associated information such as URI (Uniform Resource Identifier) to the user terminal apparatus 13. The acquisition block 54 as acquisition means obtains various kinds of information from the user terminal apparatus 13, the database 14, the server 16, the content server 32, and the storage apparatus 34. The decision block 55 as decision means determines whether content is reproducible on the user terminal apparatus 13, for example. The communication block executes processing of transmitting commands to the user terminal apparatus 13 and communicating various kinds of information with the server 16 via the transmitter/receiver 33 and the Internet 15. The recording block 57 records the information received from the acquisition block 54 to the content server 32 or the storage apparatus 34. The codec conversion block 58 converts content data format and so on.

The content server 32 holds content to be outputted to the output apparatus 12 and the information associated with that content. The content includes still images, moving images, music, and so on, for example. The content-associated information includes Exif (Exchangeable Image File Format) information, comments added by a user who has taken images, and output conditions.

The transmitter/receiver 33, connected with the user terminal apparatus 13 via a communication path such as LAN or Bluetooth, transmits and receives various kinds of information. In addition, the transmitter/receiver 33 is connected to the server 16 via the Internet 15 to transmit and receive various kinds of information.

The storage apparatus 34 as storage means stores user information and terminal information of the user terminal apparatus 13. The user information includes name, age, gender, preference of a user, for example. The terminal information includes model name, identification number, and other identification information of the user terminal apparatus 13, for example.

The output apparatus 12 is made up of a display monitor for showing images and a loudspeaker for outputting music, for example.

The database 14 is made up of a terminal information database (DB) 71 and a codec information DB 72.

The terminal information DB 71 holds codec information available to the user terminal apparatus 13 on the basis of the terminal information of the user terminal apparatus 13. The codec information DB 72 holds codec installer information necessary for content conversion on the basis of codec information.

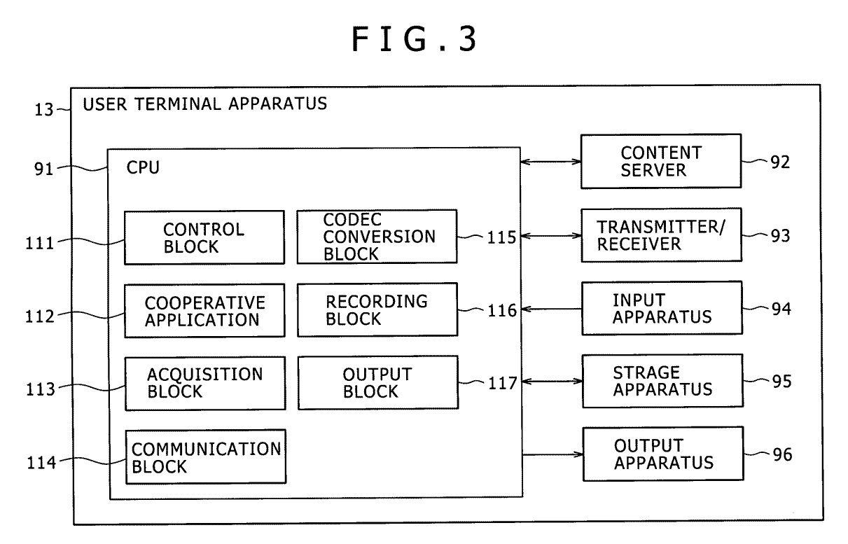

Referring to FIG. 3, there is shown a block diagram illustrating an exemplary configuration of the user terminal apparatus 13 of the information output system 1 shown in FIG. 1.

In the example shown in FIG. 3, the user terminal apparatus 13 has a CPU 91, a content server 92, a transmitter/receiver 93, an input apparatus 94, a storage apparatus 95, and an output apparatus 96. The CPU 91 has functional blocks such as a control block 111, the cooperative application 112, an acquisition block 113, a communication block 114, a codec conversion block 115, a recording block 116, and an output block 117.

These blocks of the CPU 91 are capable of transferring signals (or data) in between as required.

The control block 111 of the CPU 91 executes the processing of starting up the cooperative application 112 and the content server 92 and installing the codec. The cooperative application 112 executes the processing of establishing connection with the cooperative application 53 of the host apparatus 11 and transmitting content and content-associated information such as URI to the host apparatus 11. The acquisition block 113 executes the processing of obtaining various kinds of information from the server 16 and the storage apparatus 95. The communication block 114 executes the processing of communicating various kinds of information with the server 16 via the transmitter/receiver 93 and the Internet 15. The codec conversion block 115 executes the processing of converting the data format of content. The recording block 116 records the content acquired by the acquisition block 113 to the content server 92 and the user information and terminal information to the storage apparatus 95. The output block 117 executes the processing of outputting content to the output apparatus 96.

The content server 92 holds content and content-associated information.

The transmitter/receiver 93, connected to the host apparatus 11 and another user terminal apparatus 13 via a communication path such as LAN or Bluetooth, transmits and receives various kinds of information. In addition, the transmitter/receiver 93 is connected to the server 16 via the Internet 15 to transmit and receive various kinds of information.

The input apparatus 94 is operated by the user to enter predetermined information through a user interface, such as keys, switches, and buttons, for example. The storage apparatus 95 stores user information and terminal information.

The output apparatus 96 is based on a display monitor for outputting images and a loudspeaker for outputting sound, for example.

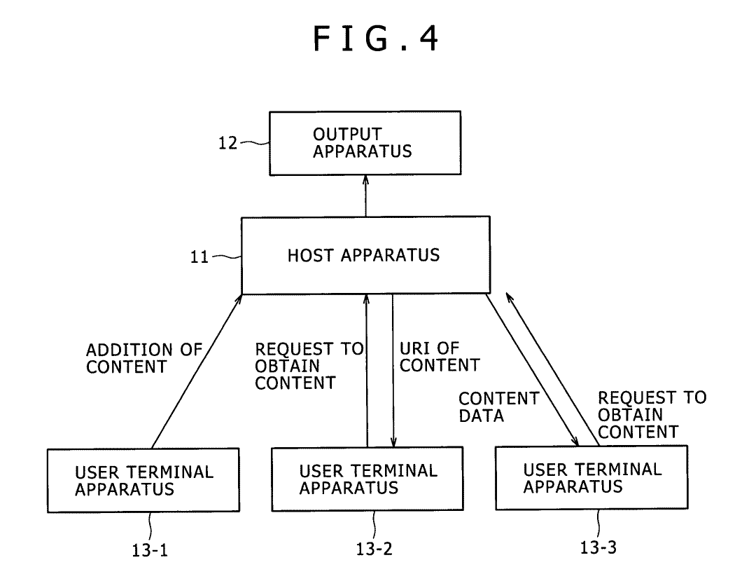

Referring to FIG. 4, there is shown an outline of the processing to be executed between the host apparatus 11 and the user terminal apparatus 13.

The user terminal apparatus 13-1 instructs the host apparatus 11 for the addition of content. Upon this instruction, the host apparatus 11 adds content to be outputted to the output apparatus 12.

Consequently, while a piece of content is being displayed, another piece of content can be added to the displayed content, thereby realizing an information output system of a user participating type and of variety.

If the user intends to obtain the content outputted to the output apparatus 12, the user terminal apparatuses 13-2 and 13-3 transmit a content acquisition request to the host apparatus 11. In response, the host apparatus 11 transmits the content outputted to the output apparatus 12 or the content URI to the user terminal apparatuses 13-2 and 13-3.

### [Basic Processing of Content Addition]

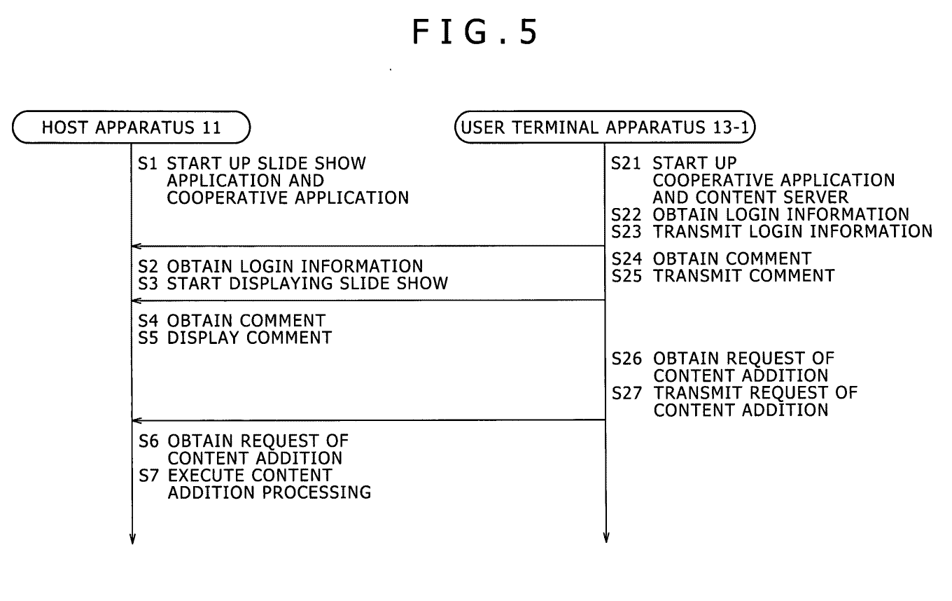

Referring to FIG. 5, there is shown a flowchart indicative of content addition processing of the host apparatus 11 and the user terminal apparatus 13-1.

On the left side of FIG. 5, the processing of the host apparatus 11 is shown. On the right side of FIG. 5, the processing of user terminal apparatus 13-1 is shown. It should be noted that arrows between both the apparatuses are indicative of information flows.

In step S1, the control block 51 of the host apparatus 11 starts up the slide show application 52 and the cooperative application 53. The slide show application 52 prepares the outputting of a slide show operation to the output apparatus 12. The cooperative application 53 waits until the connection is established with the user terminal apparatus 13-1.

In step S21, the control block 111 of the user terminal apparatus 13-1 starts up the cooperative application 112 and the content server 92. The cooperative application 112 establishes the connection with the cooperative application 53 of the host apparatus 11. The content server obtains in a state where the content server 92 is accessible from the host apparatus 11 and the other user terminal apparatuses 13-2 through 13-N.

In step S22, the user operates the input apparatus to enter user name and password, for example. The acquisition block 113 obtains these user name and password as login information. In addition, the acquisition block 113 obtains an IP address and a Mac address, for example, from the storage apparatus 95 as login information.

In step S23, the communication block 114 transmits the login information acquired in step S22. To be more specific, the login information is transmitted from the transmitter/receiver 93 to the host apparatus 11 via a communication path such as LAN or Bluetooth.

In step S2, the acquisition block 54 of the host apparatus 11 obtains the login information via the transmitter/receiver 33. This login information is one transmitted from the user terminal apparatus 13-1.

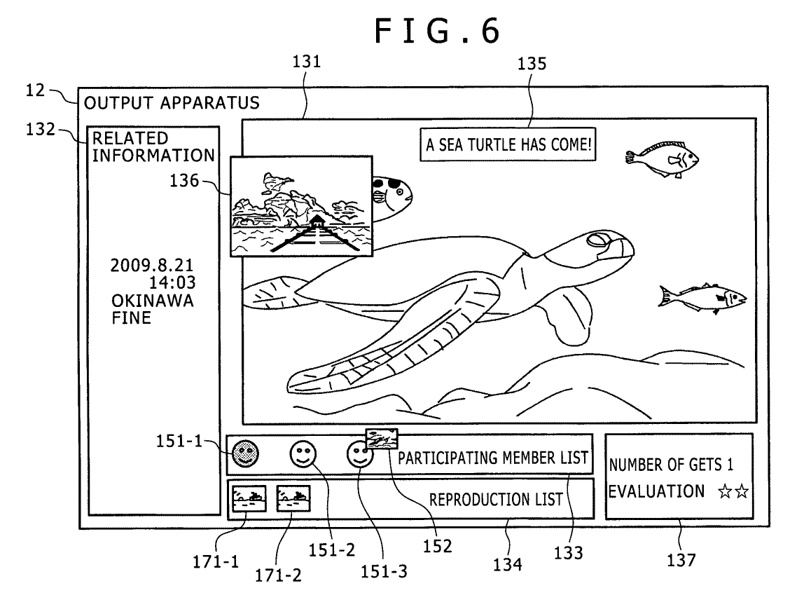

In step S3, the slide show application 52 starts displaying a slide show. To be more specific, the slide show application 52 outputs the pieces of content prepared in the content server 32 to the output apparatus 12 in a predetermined sequence, thereby displaying the outputted content. The output apparatus 12 displays the content as shown in FIG. 6, for example.

Referring to FIG. 6, there is shown an example of content displayed on the output apparatus 12. In this example, a turtle is displayed as display content 131.

It should be noted that, as shown in FIG. 6, the display content 131 can be displayed not only in a part of screen (the upper right area on the screen in the example shown in FIG. 6), but also on the entire screen, as superimposed with an additional piece of content, or in partitioned screens at the same time.

On the left side of the display content 131, associated information 132 is displayed. The associated information 132 is the content-associated information held in the content server 32. The associated information 132 may be obtained before the content is displayed and the obtained information may be stored in the content server 32. Alternatively, the associated information 132 may be obtained realtime.

In obtaining the associated information 132 realtime, the associated information 132 may be obtained from the server 16 via the Internet 15 or from the content server 92 of the user terminal apparatus 13.

In the example shown in FIG. 6, an image of turtle taken in Okinawa is displayed as the display content 131, for example, so that image taking date and time “Aug. 21, 2009” and “14:03,” image taking location “Okinawa,” and image taking weather “Fine” are displayed as the associated information 132. In order to display current date and weather, for example, the information thereof is obtained realtime.

If “a photograph of baseball player” is displayed as the display content 131, for example, the associated information 132 may include a profile of that baseball player and the history and scores of matches of the team of that baseball player, for example.

Namely, the associated information 132 includes various kinds of information associated with the display content 131.

In the lower side of the display content 131, a member list 133 is displayed. The member list 133 shows avatars 151-1 through 151-N (N=3 in the example shown in FIG. 6) corresponding to participating users who are currently logged in. It should be noted that the avatars 151-1 through 151-N are generically referred to as an avatar 151 unless noted specifically.

The avatar 151 may be stored in the storage apparatus 34 as user information in advance and obtained therefrom on the basis of login information or may be obtained along with the login information of the user terminal apparatus 13. In the example shown in FIG. 6, the user of the avatar 151-1 added an image (namely, posted an image) and the added image is being displayed as the display content 131, so that the avatar 151-1 is displayed in a color different from the other avatars 151-2 and 151-3 for distinction.

Below the member list 133, a reproduction list 134 is displayed. The reproduction list 134 displays the content to be displayed next. The storage apparatus 34 stores a queue for storing the sequence of pieces of content to be displayed in a slide show. The reproduction list 134 displays the thumbnails of the pieces of content from the content specified at the beginning of the queue in an sequential manner. In the example shown in FIG. 6, thumbnails 171-1 and 171-2 are displayed.

In addition, the output apparatus 12 displays a posted comment 135, added content 136, and an evaluation window 137, of which details will be described later.

In step S24 shown in FIG. 5, the acquisition block 113 of the user terminal apparatus 13-1 obtains a comment. Namely, the user operates the input apparatus 94 to enter a comment to be added to an added piece of content. This comment is obtained by the acquisition block 113.

In step S25, the cooperative application 112 transmits the obtained comment. Namely, the comment is transmitted to the host apparatus 11 via the transmitter/receiver 93.

In step S4, the acquisition block 54 of the host apparatus 11 obtains the comment transmitted from the user terminal apparatus 13-1. In step S5, the slide show application 52 displays the obtained comment at a predetermined position of the output apparatus 12.

In the example shown in FIG. 6, “A sea turtle has come!” is displayed as the posted comment 135 obtained as described above.

For the posted comment 135, a comment to the display content 131 obtained from the user terminal apparatus 13 is displayed. In addition to a comment, the slide show application 52 may obtain, from the user terminal apparatus 13, information about stamping or scribbling the display content 131 to display this information on the output apparatus 12.

In step S26, the acquisition block 113 of the user terminal apparatus 13-1 obtains a request to add content. Namely, the user operates the input apparatus 94 to enter the request to add content. This request is obtained by the acquisition block 113.

In step S27, the cooperative application 112 transmits the request to add content. Namely, the request to add content is transmitted to the host apparatus 11 via the transmitter/receiver 93.

It should be noted that the processing of step S24 and step S25 and the processing of step S26 and step S27 can be executed any time while a slide show is being displayed.

In step S6, the acquisition block 54 of the host apparatus 11 obtains the content URI and output condition that are the output information transmitted from the user terminal apparatus 13-1 in step S27.

In step S7, the slide show application 52 executes the content addition processing. It should be noted that, while a slide show is being displayed, the processing of step S4 and step S5 and the processing of step S6 and step S7 can be executed any time after the execution of the processing of step S24 and step S25 and the processing of step S26 and step S27.

### [Content Addition Processing by the Host Apparatus (1)]

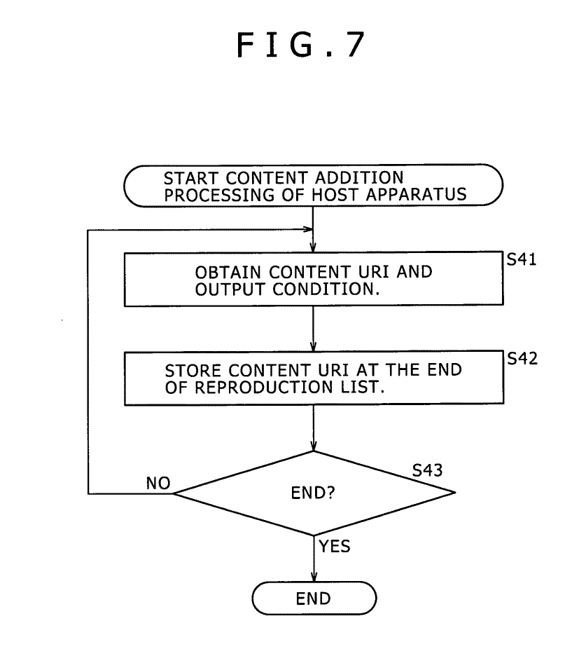

The following describes details of the content addition processing of step S7 with reference to FIG. 7.

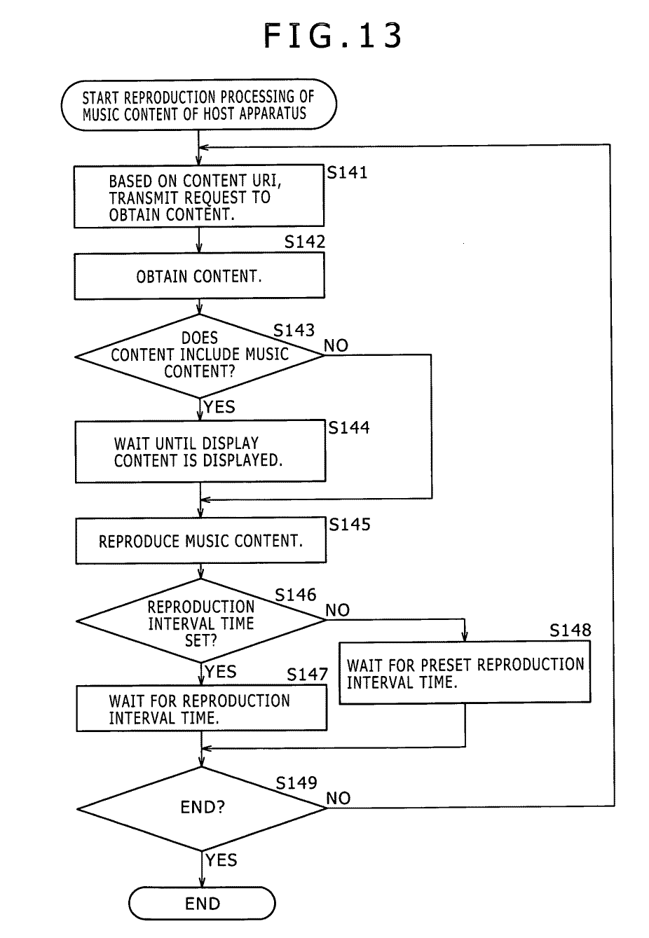

Referring to FIG. 7, there is shown a flowchart indicative of display content addition processing to be executed by the host apparatus 11. This processing shows details of the processing of adding content to be displayed on the output apparatus 12 described in step S7 shown in FIG. 5. The processing of adding content for reproducing music will be described later with reference to FIG. 13.

In step S41, the acquisition block 54 obtains the content URI and output condition transmitted from the user terminal apparatus 13-1 as output information. The output condition describes the priority, size, display position, and display interval of content, for example. It should be noted that content can be obtained by use of the URI thereof and as data.

In step S42, the slide show application 52 stores the content URI obtained in step S41 at the last of the reproduction list 134. To be more specific, as described above, the content URI transmitted from the user terminal apparatus 13-1 is stored at the last of the queue corresponding to the reproduction list 134, the queue being configured in the storage apparatus 34. The pieces of content are sequentially outputted from the left side of the queue, so that the added content is added to the last sequential number (namely, the rightmost side).

In step S43, the slide show application 52 determines whether the slide show has come to an end. If the slide show is found not ended, then the procedure returns to step S41 to repeat the processing therefrom.

If the slide show is found ended in step S43, then the content addition processing by the host apparatus 11 comes to an end.

### [Content Display Processing by the Host Apparatus (1)]

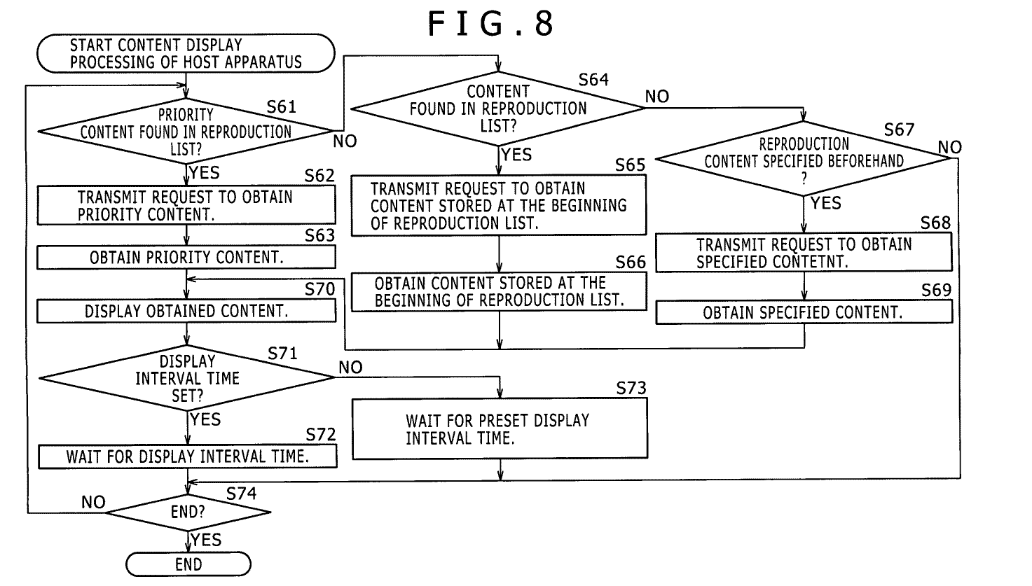

The following describes the processing to be executed when displaying content on the output apparatus 12 with reference to the flowchart shown in FIG. 8.

Now, referring to FIG. 8, there is shown the flowchart indicative of content display processing to be executed by the host apparatus 11. This processing shows details of the processing that is executed to display, on the output apparatus 12, the content added to the reproduction list 134 in the content addition processing shown in FIG. 7.

In step S61, the slide show application 52 determines whether priority content is included in the reproduction list 134. Namely, the slide show application 52 determines whether a piece of content specified as priority content by the output condition obtained in step S41 shown in FIG. 7 is included in the list.

If priority content is found in the reproduction list 134, then the communication block 56 accesses the URI of this priority content to transmit a request to obtain content in step S62. For the URI, any given user terminal apparatus 13, database 14, or server 16 is specified, for example.

In step S63, the acquisition block 54 obtains the priority content based on the specified URI.

If no priority content is found in the reproduction list 134 in step S61, then the slide show application 52 determines, in step S64, whether content is found in the reproduction list 134. Namely, it is determined whether there is any non-prioritized (or normal) content in the reproduction list 134.

If normal content is found in the reproduction list 134, then the communication block 56 transmits, in step S65, a request to obtain that content by accessing the URI of the content stored at the beginning of the reproduction list 134.

In step S66, the acquisition block 54 obtains the content stored at the beginning of the reproduction list 134 from the specified URI.

If no normal content is found in the reproduction list 134 in step S64, then the slide show application 52 determines, in step S67, whether display content is specified beforehand. Namely, it is determined whether there is any content prepared by the user of the host apparatus 11.

If prepared content is found, then the communication block 56 transmits, in step S68, a request to obtain the content by accessing the URI of the specified content. If no prepared content is found, then the procedure goes to step S74.

In step S69, the acquisition block 54 obtains the prepared content on the basis of the specified URI.

After the processing operations of steps S63, S66, and S69, the slide show application 52 displays, in step S70, the content obtained in step S63, S66, or S69. In addition, the slide show application 52 executes the processing of changing colors of the avatar 151-1, among the avatars 151-1 through 151-N, which corresponds to the user terminal apparatus 13-1 from which content has been added. Namely, the avatar 151-1 shown in FIG. 6 is explicitly shown as the poster of the content, for example.

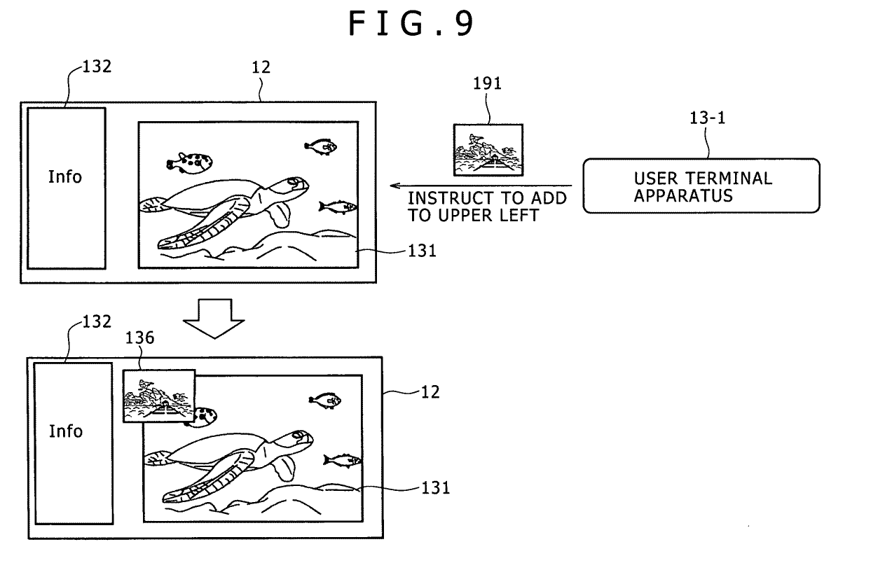

FIG. 9 shows a display example in which the size and display position of content are specified for the output condition. FIG. 9 is a diagram illustrating an example in which an output condition is specified to display a small piece of content on the upper left of the display content 131 in a superimposed manner.

The user terminal apparatus 13-1 sets a condition that the URI of display content 191 and display content 191 itself be displayed on the upper left of the display content 131 in a superimposed manner and transmits the output condition to the host apparatus 11.

Under the control of the host apparatus 11, the output apparatus 12 adds the display content 191 obtained from the user terminal apparatus 13 in accordance with the output condition. The added content is displayed with a part of the added content superimposingly displayed on the display content 131 so as to be displayed as the added content 136.

In step S71 shown in FIG. 8, the slide show application 52 determines whether a display interval time is set as an output condition. If a display interval time is found set, then the slide show application 52 waits for a display interval time in step S72. Namely, the content is displayed on the output apparatus 12 for the display interval time.

If a display interval time is found not set, then the slide show application 52 waits, in step S73, for a display interval time set to the storage apparatus 34 beforehand.

After the processing operations of steps S72 and S73 and, if reproduction content is found not specified in step S67, then the slide show application 52 determines, in step S74, whether the slide show is ended. If the slide show is found not ended, then the procedure returns to step S61 to repeat the above-mentioned processing therefrom.

If the slide show is found ended in step S74, then the content display processing by the host apparatus 11 comes to an end.

As described above, the host apparatus 11 can display the content added from another user terminal apparatus during a slide show. In addition, even if the host apparatus 11 holds no content data, the host apparatus 11 can display content by referencing the URI of content.

### [Content Addition Processing by the Host Apparatus (2)]

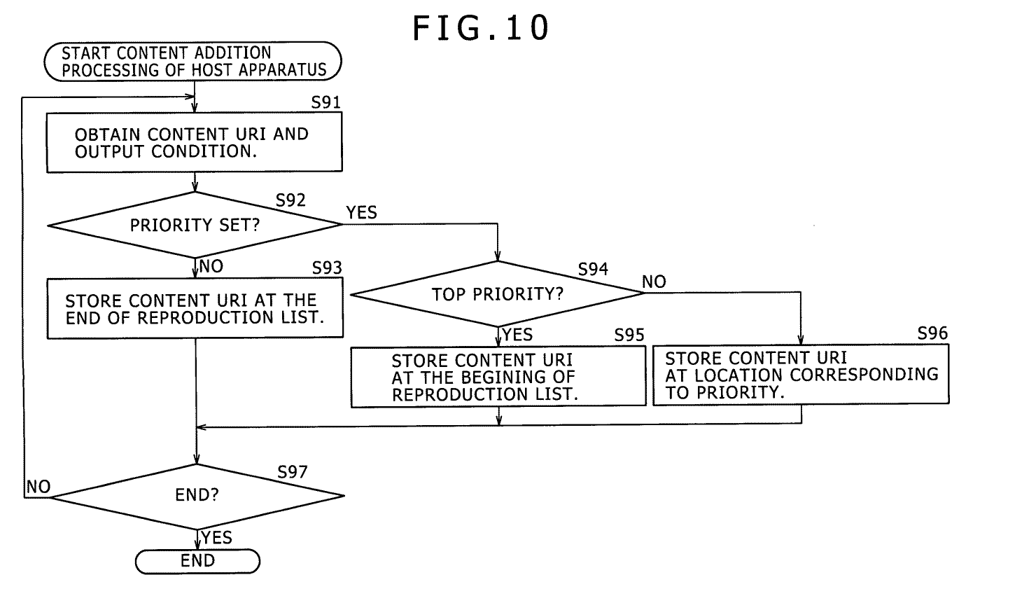

Referring to FIG. 10, there is shown a flowchart indicative of another processing example of the content addition processing of step S7 shown in FIG. 5.

In the example shown in FIG. 10, it is assumed that priority be attached to content as an output condition.

It should be noted that priority is specified as a top priority or priority M. With priority M, as an M value gets larger, priority gets higher.

In step S91, the acquisition block 54 obtains the URI of content and the output condition transmitted from the user terminal apparatus 13-1 that are output information.

In step S92, the slide show application 52 determines whether the output condition obtained in step S91 is set with priority.

If priority is found not set, then the slide show application 52 stores, in step S93, the content URI obtained in step S91 at the last of the reproduction list 134.

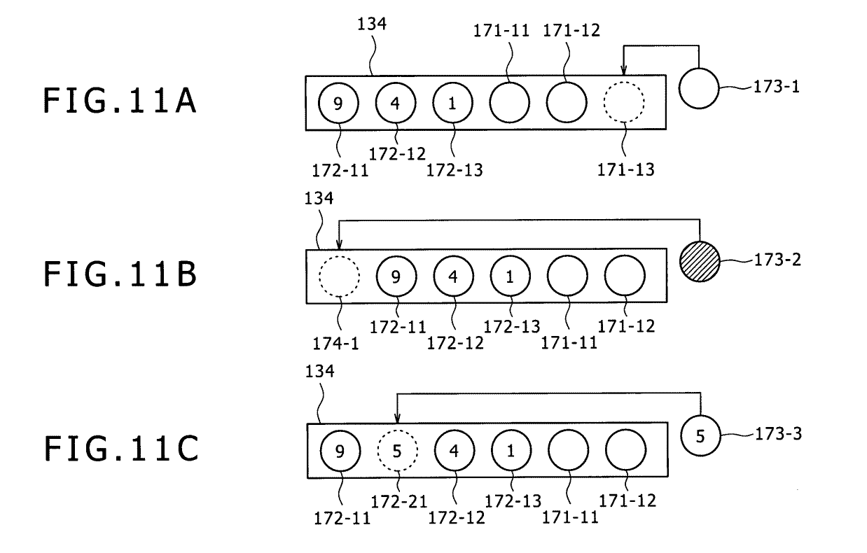

FIG. 11A shows an example in which content is added to the reproduction list 134 if priority is found not set. In the example shown in FIG. 11A, priority content 172-11 through 172-13 and content 171-11 and 171-12 are stored in the reproduction list 134.

In the state shown in FIG. 11A, the added content 173-1 to be newly added to the reproduction list 134 is not set with priority, so that the added content 173-1 is stored at a position indicated as content 171-13 in dashed lines at the last (the rightmost) of the reproduction list 134.

If priority is found set in step S92 shown in FIG. 10, then the slide show application 52 determines whether priority is top priority in step S94.

If priority found to be top priority, then the slide show application 52 stores, in step S95, the content URI obtained in step S91 at the beginning of the reproduction list 134.

If priority is top priority, an example in which the content is added to the reproduction list 134 is shown in FIG. 11B. In the example shown in FIG. 11B, added content 173-2 to be newly added to the reproduction list 134 is the top priority content, so that the added content 173-2 is stored at a position indicated as top-priority content 174-1 in dashed lines at the beginning (or the leftmost) of the reproduction list 134.

It should be noted that, if top-priority content 174-N is already stored when adding top-priority content to the reproduction list 134, the added-content 173-2 is stored at the beginning (or the leftmost) of the reproduction list 134.

If priority is found not to be top priority in step S94 shown in FIG. 10, then the slide show application 52 stores the content URI obtained in step S91 at a position in accordance with the priority in the reproduction list 134 in step S96.

FIG. 11C shows an example in which content is added to a position in accordance with the priority in the reproduction list 134. In the example shown in FIG. 11C, priority 5 is set to added content 173-3 to be newly added to the reproduction list 134. In the reproduction list 134, priority content 172-11 having priority 9, priority content 172-12 having priority 4, and priority content 172-13 having priority 1 are stored.

Because the priority of the added content 173-3 is 5, the added content 173-3 is stored at position indicated as priority content 172-21 between the priority content 172-11 having priority 9 and the priority content 172-12 having priority 4.

It should be noted that, if, when adding content at a position in accordance with priority to the reproduction list 134, priority content 172-N having the same priority as that of added content 173-3 is already stored, the added content 173-3 is stored at a position (to the right side of the priority content 172-N) to be reproduced after the priority content 172-N.

Referring to FIG. 10 again, if content is stored in the reproduction list 134 in step S93, S95, or S96, then the slide show application 52 determines in step S97 whether the slide show is ended. If the slide show is found not ended, then the procedure returns to step S91 to repeat the above-mentioned processing therefrom.

If the slide show is found ended in step S97, the content addition processing by the host apparatus 11 comes to an end.

### [Content Display Processing by the Host Apparatus (2)]

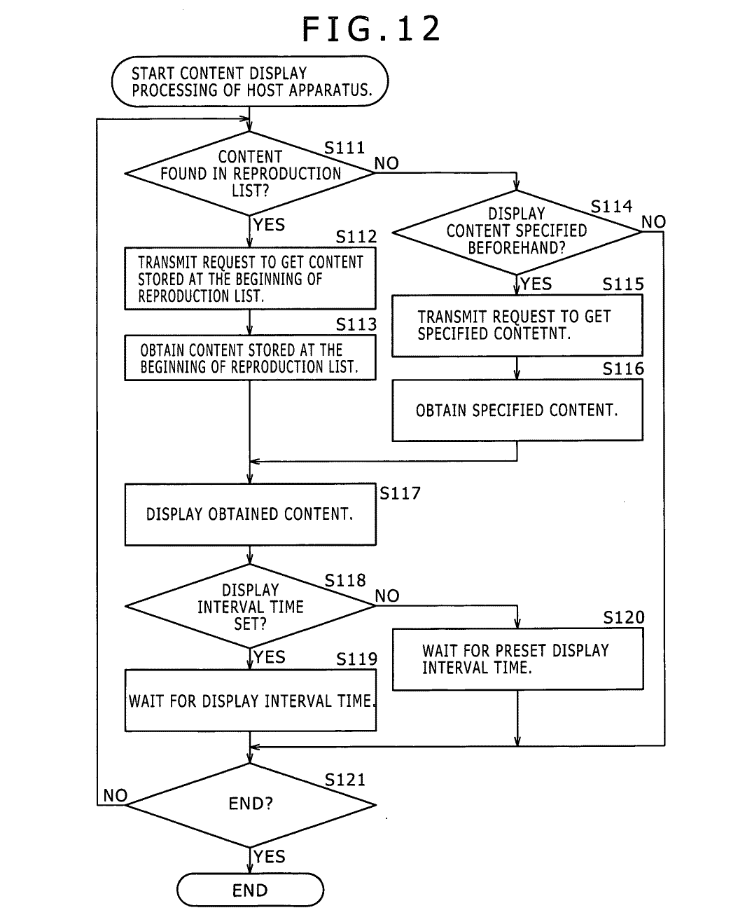

The following describes another processing example of displaying content on the output apparatus 12 with reference to the flowchart shown in FIG. 12.

Referring to FIG. 12, there is shown the flowchart indicative of the content display processing by the host apparatus 11. This flowchart shows details of processing to display, on the output apparatus 12, the content added to the reproduction list 134 by the content addition processing shown in FIG. 10.

In step S111, the slide show application 52 determines whether there is content in the reproduction list 134. Namely, the slide show application 52 determines whether the content URI obtained in step S91 shown in FIG. 10 exists in the reproduction list 134.

If content is found in the reproduction list 134, then the communication block 56 accesses the content URI located at the beginning of the reproduction list 134 in step S112 and transmits a request to obtain the content.

In step S113, the acquisition block 54 obtains the content located at the beginning of the reproduction list 134 on the basis of the specified URI.

If no content is found in the reproduction list 134 in step S111, then the slide show application 52 determines in step S114 whether the display content is specified in advance. Namely, the slide show application 52 determines whether the content prepared by the user of the host apparatus 11 exists.

If the prepared content is found, then the communication block 56 accesses the specified content URI and transmits a request to obtain the content in step S115. If no prepared content is found, then the procedure goes to step S121.

In step S116, the acquisition block 54 obtains the prepared content on the basis of the specified URI.

After the processing operations of steps S113 and S116, the slide show application 52 displays, in step S117, the content obtained in step S113 or S116.

In step S118, the slide show application 52 determines whether a display interval time is set for an output condition. If a display interval time is found set, then the slide show application 52 waits for the display interval time in step S119. Namely, the content is displayed on the output apparatus 12 for the display interval time.

If a display interval time is found not set, then the slide show application 52 waits, in step S120, for a display interval time set to the storage apparatus 34 beforehand.

After the processing operations of steps S119 and S120, and if the display content is found not specified in step S114, then the slide show application 52 determines in step S121 whether the slide show is ended. If the slide show is found not ended, then the procedure returns to step Sill to repeat the above-mentioned processing therefrom.

If the slide show is found ended in step S201, then the content display processing by the host apparatus 11 comes to an end.

### [Music Content Reproduction Processing by the Host Apparatus]

The following describes the processing of reproducing music content to be executed by the host apparatus 11 with reference to the flowchart shown in FIG. 13.

Referring to FIG. 13, there is shown the flowchart indicative of music content reproduction processing to be executed by the host apparatus 11. FIG. 13 shows the processing to be executed when a request to add music content is obtained in step S6 shown in FIG. 5. It should be noted that the user can reproduce music content alone or in combination with display content.

In step S141, the communication block 56 accesses the URI specified by content and transmits a request to obtain content.

In step S142, the acquisition block 54 obtains content data on the basis of the URI.

In step S143, the decision block 55 determines whether the content data obtained in step S142 contains display content. Namely, the decision block 55 determines whether display content and music content have been added in combination.

If display content is found contained in the obtained content data, then the slide show application 52 waits, in step S144, until display content combined with music content is displayed.

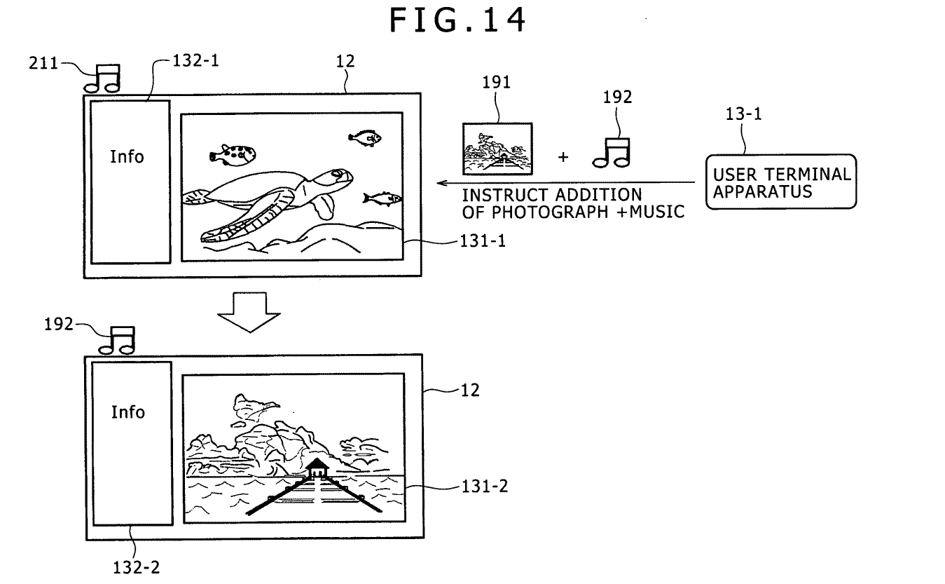

Having waited until the display timing of display content, the slide show application 52 reproduces music content in step S145. Namely, upon displaying of display content, the corresponding music content is outputted. FIG. 14 show an example in which display content and music content are obtained in combination and added at the same time.

FIG. 14 shows processing of adding display content 191 and music content 192 in combination by the user terminal apparatus 13-1.

The user terminal apparatus 13-1 obtains the URI of the display content 191 and the URI of the music content 192 and transmits the obtained URIs to the host apparatus 11.

Under the control of the host apparatus 11, the output apparatus 12 adds the display content 191 and the music content 192 obtained from the user terminal apparatus 13-1. As a result of the addition, the display content 131-1 of the output apparatus 12 is changed to the display content 131-2 that is the display content 191 obtained from the user terminal apparatus 13-1 and music content 211 of the output apparatus 12 is changed to the added music content 192.

When the content to be outputted to the output apparatus 12 is changed, the associated information 132-1 is changed to associated information 132-2.

If the display content is found not contained in the obtained content data in step S143, namely, only music content has been obtained, the processing of step S144 is skipped, upon which the procedure goes to step S145.

In step S145, the slide show application 52 reproduces the music content.

In step S146, the slide show application 52 determines whether a reproduction interval time is set as an output condition. If a reproduction interval time is found set, then the slide show application 52 waits for the reproduction interval time in step S147. Namely, the music content is reproduced by the output apparatus 12 for the reproduction interval time.

If a reproduction interval time is found not set, then the slide show application 52 waits, in step S148, for a display interval time set to the storage apparatus 34 beforehand.

In step S149, the slide show application 52 determines whether the slide show is ended. If the slide show is found not ended, the procedure returns to step S141 to repeat the above-mentioned processing therefrom.

If the slide show is found ended in step S149, the music content reproduction processing by the host apparatus 11 comes to an end.

### [Providing Content]

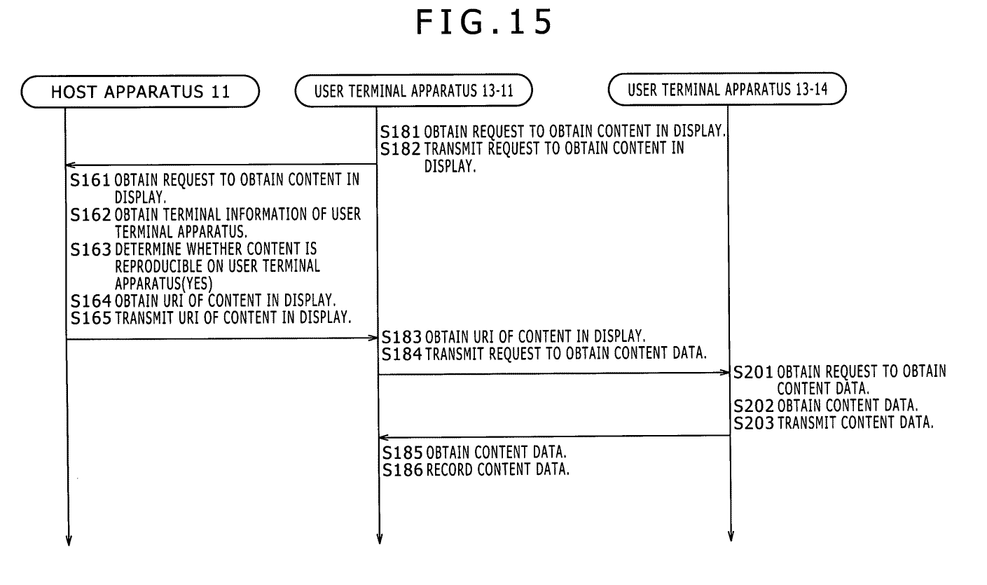

The following describes the processing of providing content being displayed on the output apparatus 12 to the user terminal apparatuses 13-11, 13-12, and 13-13 by the host apparatus 11 with reference to FIGS. 15 through 21. It should be noted that the content being displayed is assumed to have been obtained from the content server 92-14 of the user terminal apparatus 13-14.

It is also assumed that the host apparatus 11 has already executed the processing operations of steps S1 through S3 and the user terminal apparatuses 13-11, 13-12, and 13-13 have already executed the processing operations of steps S21 through S23. Namely, it is assumed that the host apparatus 11 has already started the displaying of a slide show and the user terminal apparatuses 13-11, 13-12, and 13-13 have already logged in.

Now, referring to FIG. 15, there is shown a diagram illustrating the processing if the displayed content that the user terminal apparatus 13-11 intends to obtain is reproducible (or codec-convertible) on the user terminal apparatus 13-11.

FIG. 15 shows a flowchart indicative of the content information provision processing by the host apparatus 11, the content acquisition processing by the user terminal apparatus 13-11, and the content providing processing by the user terminal apparatus 13-14 from left to right.

When the user intends to obtain the content being displayed on the output apparatus 12, the acquisition block 113 of the user terminal apparatus 13-11 obtains a request to obtain the content in display in step S181. Namely, the request to obtain the content in display entered by the user through the input apparatus 94 is obtained.

In step S182, the cooperative application 112 transmits the request to obtain the content in display. Namely, the request to obtain the content in display is transmitted to the host apparatus 11 via the transmitter/receiver 93.

In step S161, the acquisition block 54 of the host apparatus 11 obtains the request to obtain the content in display from the user terminal apparatus 13-11 via the transmitter/receiver 33.

Next, in step S162, the acquisition block 54 obtains terminal information of the user terminal apparatus 13-11 on the basis of the login information of the user terminal apparatus 13-11. Namely, the terminal information is read from the storage apparatus 34. Then, on the basis of the obtained terminal information, codec information held in the user terminal apparatus 13-11 is obtained from the terminal information DB 71 of the database 14.

In step S163, the decision block 55 determines on the basis of the terminal information and the obtained codec information whether the content in display is reproducible on the user terminal apparatus 13-11. Namely, the decision block determines whether the content in display is codec-convertible on the user terminal apparatus 13-11.

If the content in display is found reproducible (or codec-convertible) on the user terminal apparatus 13-11, then the acquisition block 54 obtains the URI of the content in display in step S164.

In step S165, the cooperative application 53 transmits the obtained URI of the content in display to the user terminal apparatus 13-11 via the transmitter/receiver 33.

Along with the processing of step S165, the slide show application 52 displays the acquisition of the content in display by the user terminal apparatus 13-11.

For example, as shown in FIG. 6, the slide show application 52 displays acquired information 152 in the upper right of an avatar 151-3 of the user terminal apparatus 13-11 that obtained the content in the member list 133 and increases “the number of Get” in the evaluation window 137 by the number of obtained persons.

The acquired information 152 is a thumbnail of the content in display. The acquired information 152 may be displayed in correspondence with the avatar 151 of the user terminal apparatus 13 that obtained the content in display.

The evaluation window 137 shows the number of users who obtained the content in display and the evaluation of the content in display. The evaluation of the content in display is executed by substantially the same processing as the processing of obtaining and displaying comments described in steps S4 and S5 shown in FIG. 5. In the example shown in FIG. 6, the content evaluation is expressed in the number of stars. As the number of stars increases, the evaluation of the content in display rises.

Here, the content information provision processing by the host apparatus 11 ends.

In step S183, the acquisition block 113 of the user terminal apparatus 13-11 obtains the URI of the content in display transmitted from the host apparatus 11.

In step S184, the communication block 114 transmits a request to obtain content data. Namely, if the obtained URI specifies the user terminal apparatus 13-14 for example, a request to obtain content data is transmitted to the user terminal apparatus 13-14 via the transmitter/receiver 93.

In step S201, the acquisition block 113 of the user terminal apparatus 13-14 obtains the request to obtain content data transmitted from the user terminal apparatus 13-11 via the transmitter/receiver 93.

In step S202, the acquisition block 113 obtains the content data from the content server 92 specified by the URI. Next, in step S203, the communication block 114 transmits the obtained content data to the user terminal apparatus 13-11 via the transmitter/receiver 93.

Here, the content provision processing of the user terminal apparatus 13-14 ends.

In step S185, the acquisition block 113 of the user terminal apparatus 13-11 obtains the content data from the user terminal apparatus 13-14 via the transmitter/receiver 93.

In step S186, the recording block 116 records the content data to the content server 92. Here, the content acquisition processing by the user terminal apparatus 13-11 ends.

As described above, the user terminal apparatus 13 can obtain, from the host apparatus 11, the content being displayed in a slide show during the reproduction thereof. It should be noted that, in the example shown in FIG. 15, content to be displayed in a slide show is shown; it is also practicable for the user terminal apparatus 13 to obtain content, such as music, for example.

### [Processing to be Executed if Content in Display is Not Reproducible on a User Terminal Apparatus]

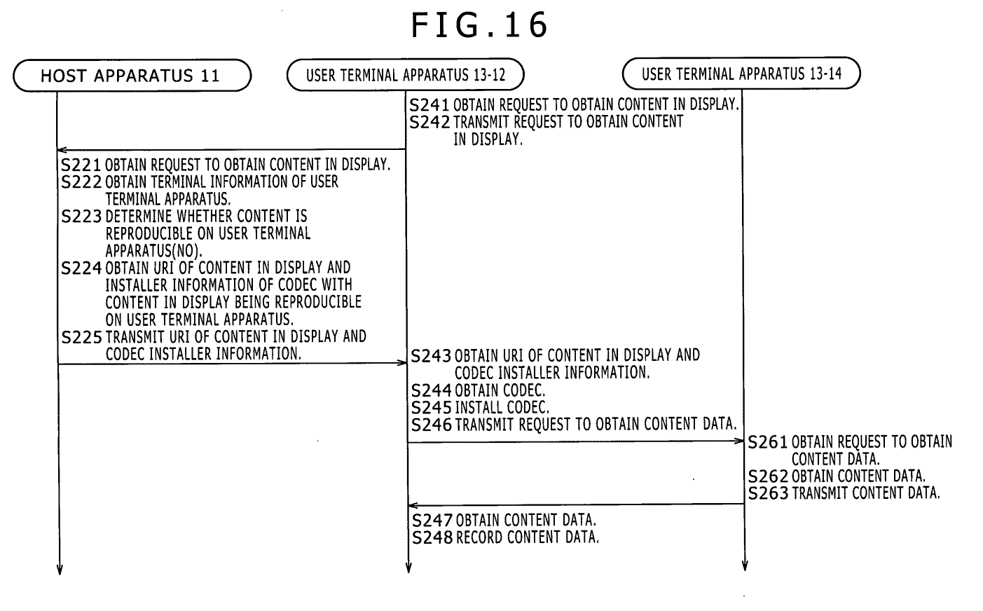

Referring to FIG. 16, there is shown a diagram explaining the processing to be executed if the content in display that the user terminal apparatus 13-12 intends to obtain is not reproducible (or not codec-convertible) on the user terminal apparatus 13-12.

FIG. 16 is a flowchart indicative of the content information provision processing by the host apparatus 11, the content acquisition processing by the user terminal apparatus 13-12, and the content provision processing by the user terminal apparatus 13-14, from left to right.

In FIG. 16, the processing operations of steps S221 and 5222 by the host apparatus 11 are substantially the same as the processing operations of steps S161 and S162 by the host apparatus 11 shown in FIG. 15. The processing operations of steps S241, S242, S247, and S248 by the user terminal apparatus 13-12 are substantially the same processing operations of steps S181, S182, S185, and S186 by the user terminal apparatus 13-11 shown in FIG. 15. The processing operations of steps S261 through S263 by the user terminal apparatus 13-14 are substantially the same processing operations of steps S201 through 203 by the user terminal apparatus 13-14 shown in FIG. 15. Therefore, details of these processing operations will be skipped for the brevity of description.

To be more specific, in step S241, the acquisition block 113 of the user terminal apparatus 13-12 obtains a request to obtain the content in display. In step S242, the cooperative application 112 transmits the request to obtain the content in display to the host apparatus 11.

In step S221, the acquisition block 54 of the host apparatus 11 obtains the request to obtain the content in display from the user terminal apparatus 13-12. In step S222, the acquisition block 54 obtains the terminal information of the user terminal apparatus 13-12 on the basis of the login information of the user terminal apparatus 13-12 and, on the basis of the obtained terminal information, obtains the information of codec available by the user terminal apparatus 13-12.

In step S223, the decision block 55 determines on the basis of the terminal information and the codec information whether the content in display is reproducible (or codec-convertible) on the user terminal apparatus 13-12.

If the content in display is found not reproducible (or not codec-convertible) on the user terminal apparatus 13-12, then the acquisition block 54 obtains the URI of the content in display in step S224 and, on the basis of the codec information, obtains the installer information of the codec with the content in display reproducible on the user terminal apparatus 13-12 from the codec information DB 72.

The installer information of codec denotes the information indicative of a location at which the codec installer can be obtained.

In step S225, the cooperative application 53 transmits the obtained URI of the content in display and codec installer information to the user terminal apparatus 13-12 via the transmitter/receiver 33.

Here, the content information provision processing by the host apparatus 11 ends.

In step S243, the acquisition block 113 of the user terminal apparatus 13-12 obtains the URI of the content in display and the codec installer information transmitted from the host apparatus 11.

In step S244, the acquisition block 113 obtains the codec on the basis of the installer information.

In step S245, the control block 111 installs the codec. This allows the codec conversion block 115 of the user terminal apparatus 13-12 to execute codec conversion, or the reproduction of the content in display.

In step S246, the communication block 114 transmits a request to obtain content data. Namely, a request to obtain content data is transmitted, via the transmitter/receiver 93, to the user terminal apparatus 13-14 specified by the URI obtained in step S243.

In step S261, the acquisition block 113 of the user terminal apparatus 13-14 obtains the request to obtain content data transmitted from the user terminal apparatus 13-12. In step S262, the acquisition block 113 obtains the content data from the content server 92 specified by the URI.

In step S263, the communication block 114 transmits the obtained content data to the user terminal apparatus 13-12. Here, the content provision processing by the user terminal apparatus 13-14 ends.

In step S247, the acquisition block 113 of the user terminal apparatus 13-12 obtains the content data transmitted from the user terminal apparatus 13-14. In step S248, the recording block 116 records the content data to the content server 92. Here, the content provision processing by the user terminal apparatus 13-12 ends.

Thus, if the content in display cannot be codec-converted by the user terminal apparatus 13-12, providing the information of the codec for making the content in display reproducible allows the reproduction of the content in display by the user terminal apparatus 13-12.

### [Content Provision Processing by the Host Apparatus]

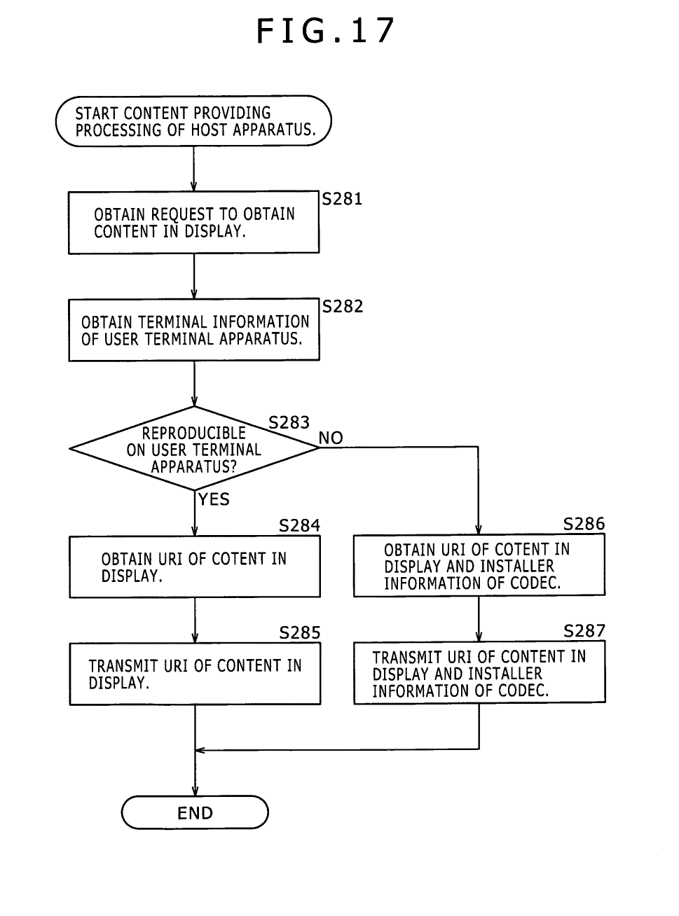

The processing operations by the host apparatus 11 described with reference to FIGS. 15 and 16 are summarized as shown in FIG. 17. FIG. 17 shows a flowchart indicative of the content provision processing to be executed by the host apparatus 11.

With detailed description omitted, in FIG. 17, the processing operations of steps S281 through S285 correspond to the processing operations of steps 5161 through S165 shown in FIG. 15 and the processing operations of steps S286 and S287 correspond to the processing operations of steps S224 and S225 shown in FIG. 16.

In step S281, the acquisition block 54 obtains the request to obtain the content in display. In step S282, the acquisition block 54 obtains terminal information of the user terminal apparatus 13 from the login information of the user terminal apparatus 13 and, on the basis of the obtained terminal information, obtains the information of codec available by the user terminal apparatus 13 as the terminal information.

In step S283, the decision block 55 determines on the basis of the obtained terminal information whether the content in display is reproducible on the user terminal apparatus 13.

If the content in display is found reproducible on the user terminal apparatus 13, then the acquisition block 54 obtains the URI of the content in display in step S284. Next, in step S285, the cooperative application 53 transmits the obtained URI of the content in display to the user terminal apparatus 13.

If the content in display is found not reproducible on the user terminal apparatus 13, then the acquisition block 54 obtains the URI of the content in display step S286 and, at the same time, obtains the installer information of codec on the basis of the codec information obtained in step S282.

Next, in step S287, the cooperative application 53 transmits the obtained URI of the content in display and the obtained installer information of codec to the user terminal apparatus 13-12. Here, the content information providing processing by the host apparatus 11 ends.

### [Processing to be Executed if Content is Not Reproducible]

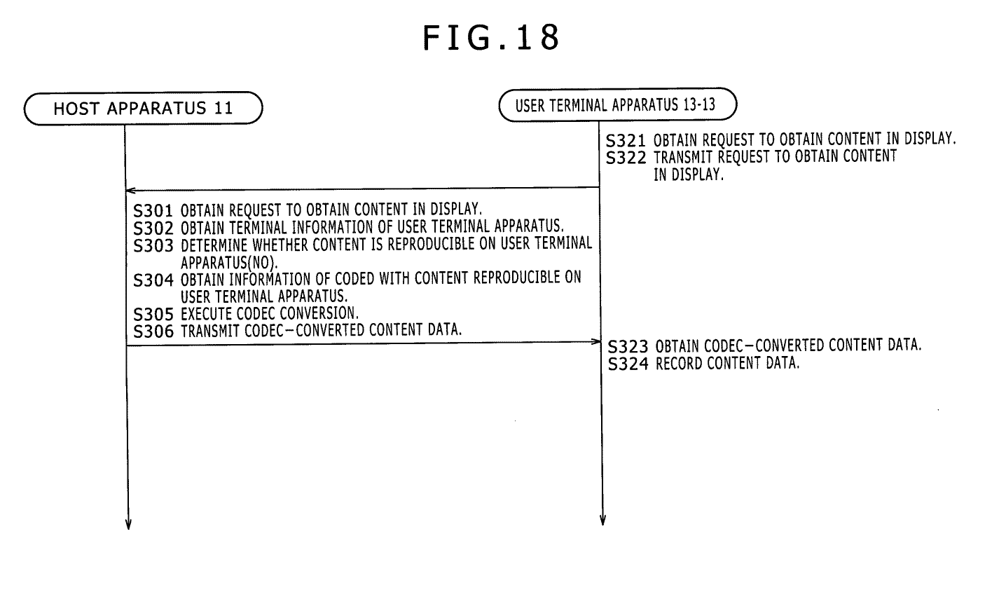

Referring to FIG. 18, there is shown a flowchart indicative of another processing operation to be executed if the content in display that the user terminal apparatus 13-13 intends to obtain is not reproducible on the user terminal apparatus 13-13.

The flowchart shown in FIG. 18 is indicative of the content information provision processing by the host apparatus 11 and the content acquisition processing by the user terminal apparatus 13-13.

With detailed description omitted, in FIG. 18, the processing operations of steps S301 and S302 by the host apparatus 11 correspond to the processing operations of steps S221 and S222 by the host apparatus shown in FIG. 16. The processing operations of steps S321, S322, S323, and S324 by the user terminal apparatus 13-13 correspond to the processing operations of S241, S242, S247, and S248 by the user terminal apparatus 13-12 shown in FIG. 16.

In step S321, the acquisition block 113 of the user terminal apparatus 13-13 obtains a request to obtain the content in display. Namely, the user operates the input apparatus 94 to enter this request, which is obtained by the acquisition block 113. In step S322, the cooperative application 112 transmits the entered request to obtain the content in display to the host apparatus 11.

In step S301, the acquisition block 54 of the host apparatus 11 obtains the request to obtain the content in display from the user terminal apparatus 13-13. In step S222, the acquisition block 54 obtains terminal information of the user terminal apparatus 13-13 from the login information of the user terminal apparatus 13-13 and, on the basis of the obtained terminal information, obtains the information of codec available on the user terminal apparatus 13-13 as the terminal information.

In step S303, the decision block 55 determines on the basis of the obtained terminal information whether the content in display is reproducible on the user terminal apparatus 13-13.

If the content in display is found not reproducible (or not codec-convertible) on the user terminal apparatus 13-13, then the acquisition block 54 obtains the information of the codec with the content reproducible on the user terminal apparatus 13-13 from the storage apparatus 34 on the basis of the terminal information in step S304.

In step S305, the codec conversion block 58 codec-converts the content in display into a codec format available on the user terminal apparatus 13-13 on the basis of the codec information obtained in step S304. Consequently, the content in display is converted into the data having a format in which codec is enabled on the user terminal apparatus 13-13.

In step S306, the cooperative application 53 transmits the content data of the content in display codec-converted in step S305. Namely, the codec-converted data is transmitted to the user terminal apparatus 13-13 via the transmitter/receiver 33. Here, the content information provision processing by the host apparatus 11 ends.

In step S323, the acquisition block 113 of the user terminal apparatus 13-13 obtains the codec-converted content data of the content in display transmitted from the host apparatus 11. In step S324, the recording block 116 records the content data to the content server 92. Here, the content acquisition processing by the user terminal apparatus 13-13 ends.

As described above, if the host apparatus 11 has the codec conversion block 58, the content data converted into the data format in which codec conversion is enabled on the user terminal apparatus 13-13 is transmitted to the user terminal apparatus 13-13, so that the user can reproduce the content in display upon the acquisition thereof.

### [Processing by the Host Apparatus]

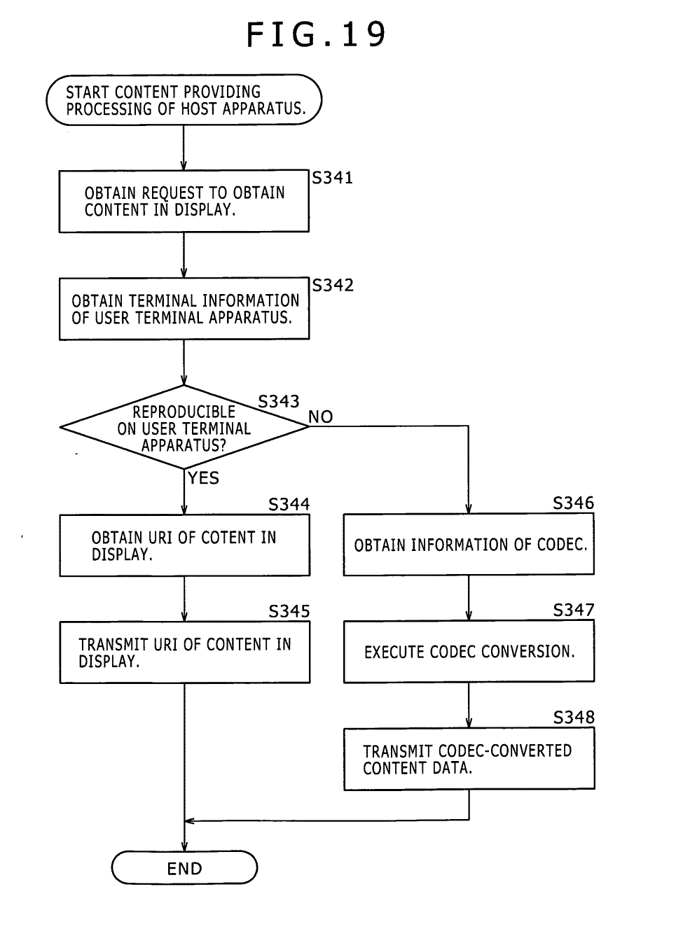

The processing operations described in FIG. 15 and FIG. 18 are summarized as shown in FIG. 19. FIG. 19 is a flowchart indicative of the content provision processing by the host apparatus 11.

In FIG. 19, the processing operations of steps S341 through S345 correspond to the processing operations of steps S161 through S165 shown in FIG. 15 and the processing operations of steps S346 through S348 correspond to the processing operations of steps S304 through S306 shown in FIG. 18. Therefore, detailed description of these processing operations will be skipped for the brevity of description.

In step S341, the acquisition block 54 obtains a request to obtain the content in display. In step S342, the acquisition block 54 obtains terminal information of the user terminal apparatus 13 from the login information thereof. Next, on the basis of the obtained terminal information, the acquisition block 54 obtains the information of codec available on the user terminal apparatus 13 as the terminal information.

In step S343, the decision block 55 determines on the basis of the obtained terminal information whether the content in display is reproducible on the user terminal apparatus 13.

If the content in display is found reproducible (or codec convertible) on the user terminal apparatus 13, then the acquisition block 54 obtains the URI of the content in display in step S344. Next, in step S345, the cooperative application transmits the URI of the content in display obtained in step S344 to the user terminal apparatus 13.

If the content in display is found not reproducible (or not codec convertible) on the user terminal apparatus 13, then the acquisition block 54 obtains the codec information from the storage apparatus 34 on the basis of the terminal information obtained in step S342.

In step S347, the codec conversion block 58 codec-converts the content in display into a data format in which codec is enabled on the user terminal apparatus 13 on the basis of the codec information. Next, in step S348, the cooperative application 53 transmits the content data of the content in display codec-converted in step S347 to the user terminal apparatus 13 via the transmitter/receiver 33.

Here, the content information provision processing by the host apparatus 11 ends.

### [Outline of Content Acquisition Processing]

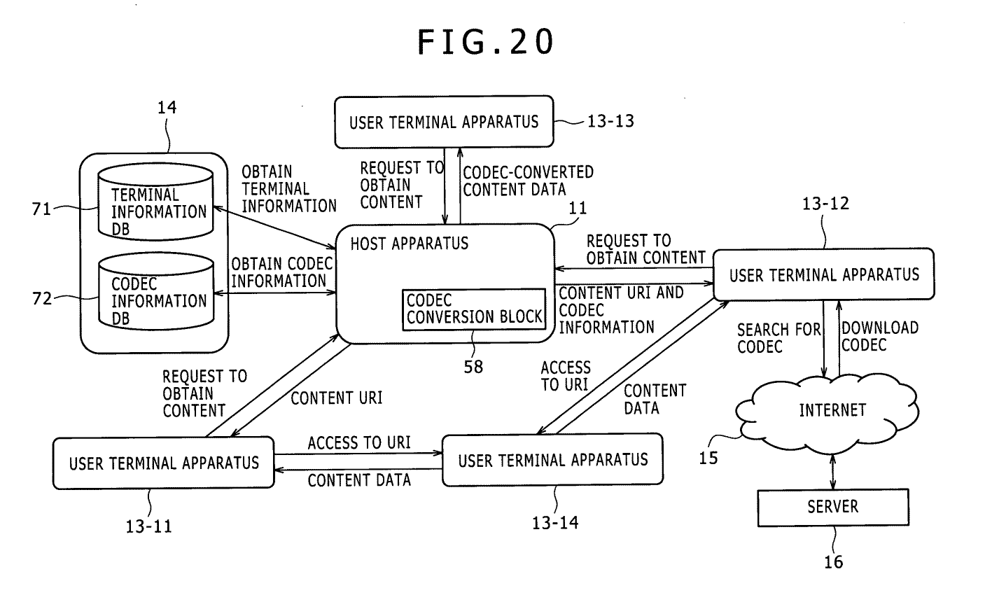

Referring to FIG. 20, there is outlined content acquisition processing to be executed between the host apparatus 11, the user terminal apparatus 13, the database 14, and the server 16 in the processing operations described with reference to FIGS. 15 through 19.

Upon receiving a content acquisition request from any of the user terminal apparatuses 13-11 through 13-13, the host apparatus 11 obtains terminal information from the terminal information DB 71 of the database 14 to determine whether the content is reproducible on any of the user terminal apparatuses 13-11 through 13-13.

If the content is found reproducible on the user terminal apparatus 13-11, the host apparatus 11 transmits the URI of the content to the user terminal apparatus 13-11.

If the content is found not reproducible on the user terminal apparatus 13-12, then the host apparatus 11 obtains the installer information of codec from the codec information DB 72 and transmits the URI of the content and the installer information of codec to the user terminal apparatus 13-12.

The user terminal apparatuses 13-11 and the 13-12 that obtained the URI of content access the user terminal apparatus 13-14 specified by the URI to obtain the content data.

The user terminal apparatus 13-12 that received the codec information searches the server 16 via the Internet 15 for the codec on the basis of the codec information and downloads the obtained codec.

If the content is not reproducible on the user terminal apparatus 13-13, then the host apparatus 11 transmits the content data codec-converted by the codec conversion block 58 to the user terminal apparatus 13-13.

### [Processing by the Database]

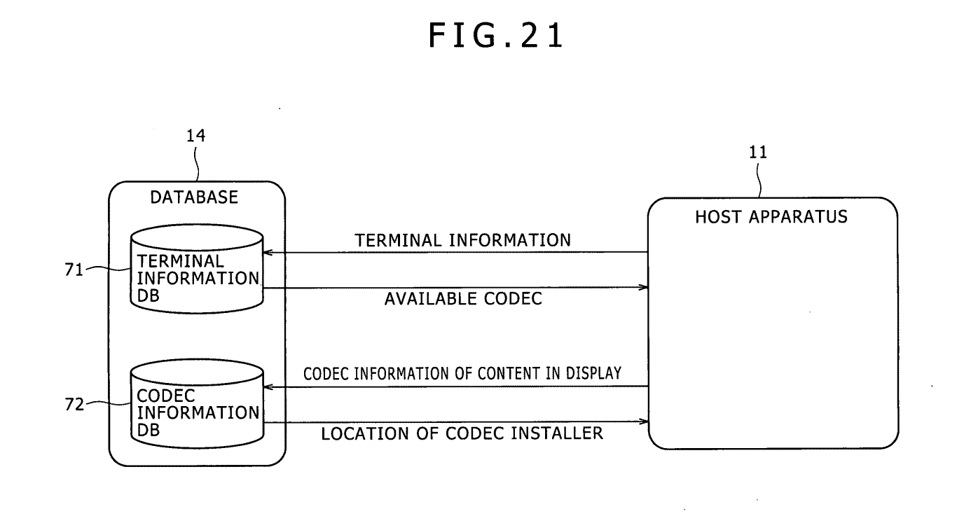

Referring to FIG. 21, there is shown processing to be executed between the host apparatus 11 and the database 14.

The host apparatus 11 transmits terminal information such as the model name and so on of the user terminal apparatus 13 to the terminal information DB 71. The terminal information DB 71 detects a codec available on the user terminal apparatus 13 on the basis of the terminal information. The host apparatus 11 obtains the codec available on the user terminal apparatus 13.

If the content in display is found not reproducible on the user terminal apparatus 13, then the host apparatus 11 transmits the codec information of the content in display to the codec information DB 72. On the basis of the codec information, the codec information DB 72 detects the installer information of the codec. The host apparatus 11 obtains the detected installer information.

Consequently, if the user terminal apparatus 13 has no codec necessary for the reproduction of the content in display, the user terminal apparatus 13 can reproduce the obtained content in display.

### [Changing Content (1)]

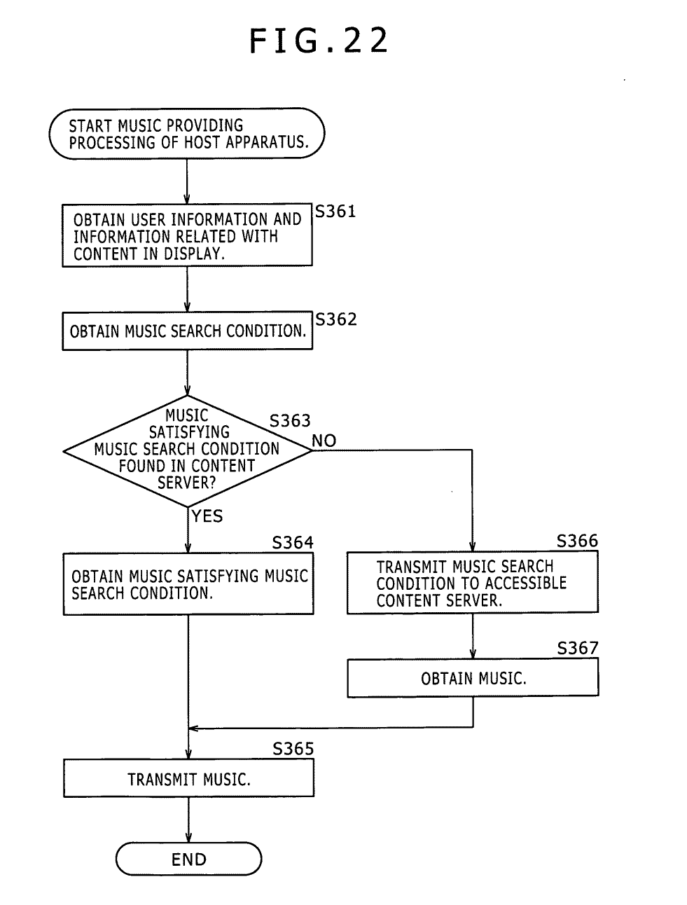

Referring to FIG. 22, there is shown a flowchart indicative of music provision processing to be executed by the host apparatus 11. In this embodiment, in the reproduction of music by the output apparatus 96, music matching the user of the user terminal apparatus 13 is selected and reproduced.

In the example shown in FIG. 22, the host apparatus 11 outputs content to the output apparatus 12 and two or more user terminal apparatuses 13 are logged in on the host apparatus 11. The processing shown in FIG. 22 is executed when the host apparatus 11 outputs music to the output apparatus 96 along with content.

In step S361, the acquisition block 54 obtains user information of the user terminal apparatus 13 and related information of the content in display. The user information of each user terminal apparatus 13 is obtained from the storage apparatus 34 and the related information of the content in display is obtained from the content server 32.

In step S362, the acquisition block 54 obtains a music search condition on the basis of the content related information and the user information. The content related information is a date on which the content was obtained and the user information is the age and gender of the user, for example.

The music search condition is obtained from the content related information and the user information. For example, if the content acquisition date is year 2000 and the user is a teenager male, the search condition is that the music of a teenager female in the upper part of music ranking in year 2000.

In step S363, the decision block 55 determines whether there is music that satisfies the music search condition in the content server 32.

If the music satisfying the music search condition is found existing in the content server 32, then the acquisition block 54 obtains the music that satisfies the music search condition in step S364.

In step S365, the cooperative application 53 transmits the obtained music to the user terminal apparatus 13.

In step S363, if the music satisfying the music search condition is not found existing in the content server 32, then the communication block 56 transmits the music search condition to the content server 92 of the accessible user terminal apparatus 13 or the server 16.

Upon reception of the music search condition, the content server 92 of the user terminal apparatus 13 or the server 16 searches for the music that satisfies the music search condition and transmits the obtained music to the host apparatus 11.

In step S367, the acquisition block 54 obtains the music satisfying the music search condition transmitted from the user terminal apparatus 13 or the server 16. Next, in step S365, the cooperative application 53 transmits the obtained music to the user terminal apparatus 13.

Here, the music provision processing executed by the host apparatus 11 ends.

The processing shown in FIG. 22 is executed for each user terminal apparatus 13. Consequently, music that is different for each user of the user terminal apparatus 13 is transmitted, so that content suitable for each user can be provided.

### [Outline of Music Search]

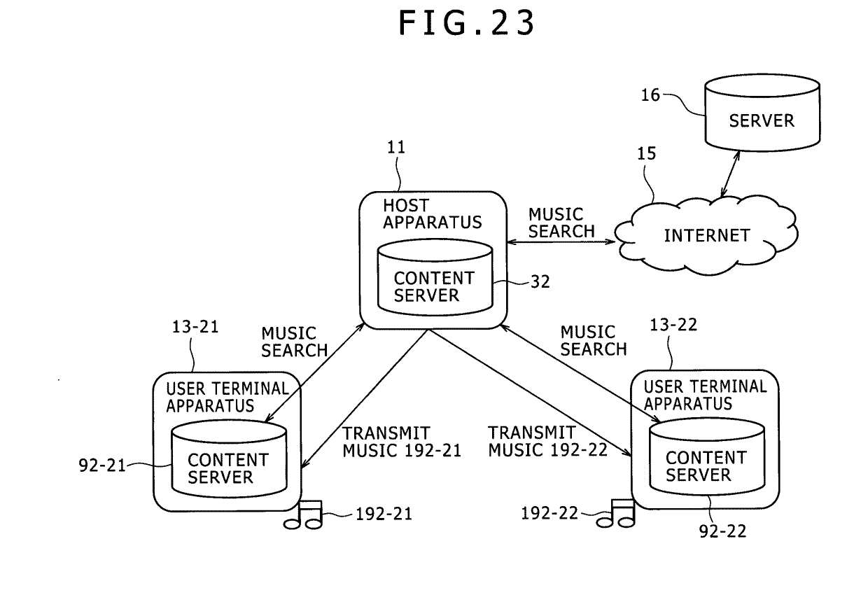

Referring to FIG. 23, there is outlined the processing for executing music search based on the music search condition.

The host apparatus 11 searches the content server 32 of the host apparatus 11, the content servers 92-21 and 92-22 of the user terminal apparatuses 13-21 and 13-22, and the server 16 for music.

Next, music content 192-21 is transmitted to the user terminal apparatus 13-21 and music content 192-22 is transmitted to the user terminal apparatus 13-22.

### [Provision of Music Desired by User]

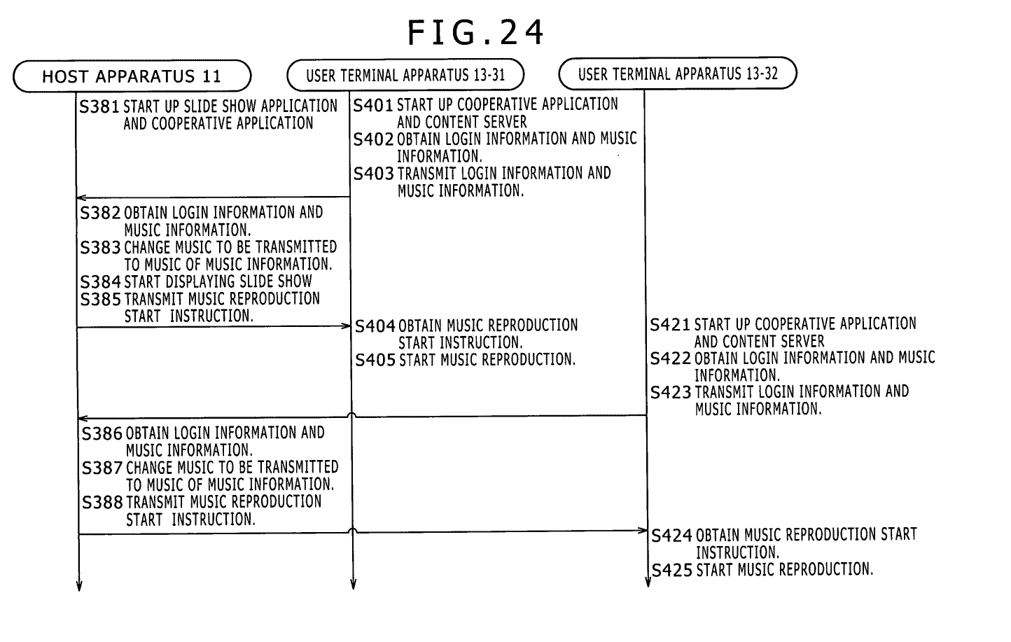

The following describes processing in which the music desired by the user is reproduced on the user terminal apparatus 13 with reference to the flowchart shown in FIG. 24.

FIG. 24 shows the flowchart indicative of output content change processing to be executed by the host apparatus 11, specified music reproduction processing to be executed by the user terminal apparatus 13-31, and specified music reproduction processing to be executed by the user terminal apparatus 13-32, from left to right.

In step S381, the control block 51 of the host apparatus 11 starts up the slide show application 52 and the cooperative application 53.

In step S401, the control block 111 of the user terminal apparatus 13-31 starts up the cooperative application 112 and the content server 92.

In step S402, the acquisition block 113 obtains login information and music information. The login information is entered by the user through the input apparatus to be obtained by the acquisition block 113. The music information is entered by the user through the input apparatus 94 or read from the content server 92 to be obtained. The music information may be the URI of the music content 192 or the content data of the music content 192.

In step S403, the cooperative application 112 transmits the login information and the music information to the host apparatus 11 via the transmitter/receiver 93.

In step S382, the acquisition block 54 of the host apparatus 11 obtains the login information and the music information transmitted from the user terminal apparatus 13-31 via the transmitter/receiver 33.

In step S383, the cooperative application 53 changes the music to be transmitted to the user terminal apparatus 13-31 from the predetermined music to be output to the output apparatus 12 to music content 192-31, not shown, of the obtained music information.

In step S384, the slide show application 52 starts displaying a slide show. At this moment, the content is displayed from the output apparatus 12 and the predetermined music is outputted.

In step S385, the cooperative application 53 transmits a music reproduction start instruction to the user terminal apparatus 13-31. To be more specific, an instruction for reproducing the changed music content 192-31 is transmitted to the user terminal apparatus 13-31 via the transmitter/receiver 33.

In step S404, the acquisition block 113 of the user terminal apparatus 13-31 obtains the music reproduction start instruction from the host apparatus 11. Namely, the music reproduction start instruction is obtained from the host apparatus 11 via the transmitter/receiver 93.

In step S405, the control block 111 starts reproducing the music on the basis of the obtained music reproduction start instruction. To be more specific, the reproduction of the music content 192-31 specified by the user in step S402 is started. The music content 192-31 is read from the content server 92 to be outputted from the output apparatus 96.

Here, the specified music reproduction processing executed by the user terminal apparatus 13-31 ends.

Consequently, the user terminal apparatus 13-31 becomes ready for starting the display of a slide show and the reproduction of the music desired by the user. It should be noted that the user views the content displayed on the output apparatus 12 as the display content.

The user of the user terminal apparatus 13-32 can also hear desired music in the same manner as described above. In the example shown in FIG. 24, the user terminal apparatus 13-32 reproduces the desired music content 192-32, not shown, after the display of a slide show has started.

Namely, in step S421, the control block 111 of the user terminal apparatus 13-32 starts up the cooperative application 112 and the content server 92. In step S422, the acquisition block 113 obtains the login information and the music information.

In step S423, the cooperative application 112 transmits the login information and the music information to the host apparatus 11.

In step S386, the acquisition block 54 of the host apparatus 11 obtains the login information and the music information. In step S387, the cooperative application 53 changes the music to be transmitted to the user terminal apparatus 13-32 to the music content 192-32, not shown, of the obtained music information.

In step S388, the cooperative application 53 transmits an instruction for starting the reproduction of the changed music content 192-32 to the user terminal apparatus 13-32.

In step S424, the acquisition block 113 of the user terminal apparatus 13-32 obtains the music reproduction start instruction from the host apparatus 11. In step S425, the control block 111 starts reproducing the music. At this moment, in the user terminal apparatus 13-32, the music content 192-32 is read from the content server 92 to be outputted from the output apparatus 96. Here, the specified music reproduction processing executed by the user terminal apparatus 13-32 ends.

As described above, the user of the user terminal apparatus 13-32 can reproduce desired music while a slide show is displayed. In this case, the user also views the content displayed on the output apparatus 12 as the display content.

### [Specified Music Reproduction Processing]

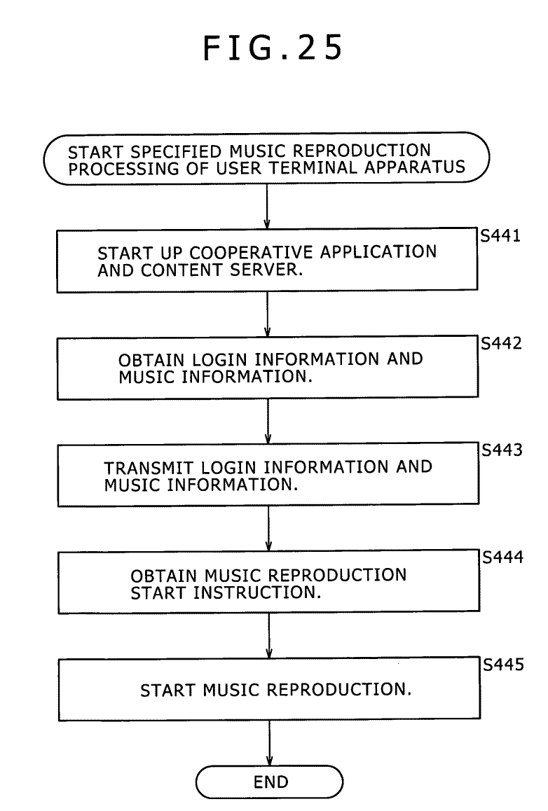

The processing operations executed by the user terminal apparatus 13 shown in FIG. 24 are summarized as shown in FIG. 25. FIG. 25 shows a flowchart indicative of the specified music reproduction processing by the user terminal apparatus 13.

In FIG. 25, the processing operations of steps S441 through S445 correspond to the processing operations of steps S401 through S405 and steps S421 through S425 shown in FIG. 24. Therefore, the description of details of these corresponding steps will be skipped for the brevity of description.

In step S441, the control block 111 starts up the cooperative application 112 and the content server 92. In step S442, the acquisition block 113 obtains login information and music information. In step S443, the cooperative application 112 transmits the login information and the music information to the host apparatus 11.

In step S444, the acquisition block 113 obtains a music reproduction start instruction from the host apparatus 11. In step S445, the control block 111 starts reproducing the music content 192.

Here, the specified music reproduction processing executed by the user terminal apparatus 13 ends.

### [Changing Content (2)]

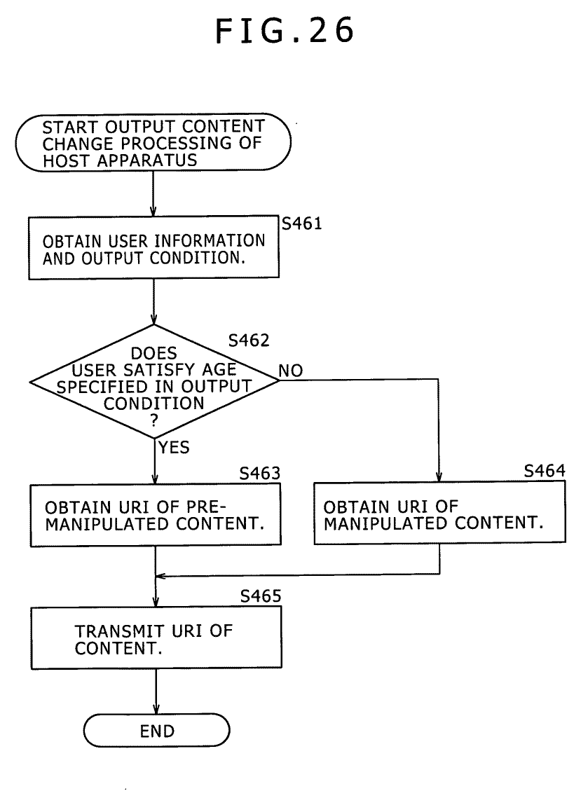

The following describes the processing for changing output content with reference to the flowchart shown in FIG. 26.

FIG. 26 is a flowchart indicative of the output content change processing to be executed by the host apparatus 11. In this example, a content display restriction by age is set.

It should be noted that an age requirement is set for a content display output condition in the content related information. It is also assumed that the user terminal apparatus 13 be in the login state.

In step S461, the acquisition block 54 obtains the user information and the output condition. The user information of the user terminal apparatus 13 is obtained from the storage apparatus 34 and the output condition included in the content related information is obtained from the content server 32.

In step S462, the decision block 55 determines on the basis of the user information and the output condition whether the user satisfies the age requirement set to the output condition.

If the user is found satisfying the age requirement, then the acquisition block 54 obtains the URI of the content before being manipulated such as blurring in step S463. This URI is obtained from the content server 32.

In step S465, the cooperative application 53 transmits the obtained content URI to the user terminal apparatus 13. This transmission is executed via the transmitter/receiver 33.

As described above, if the user satisfies the age requirement, the content before manipulation such as blurring is transmitted to the user terminal apparatus 13 of that user and is displayed thereon.

On the other hand, if the user is found not satisfying the age requirement set to the output condition in step S462, then the acquisition block 54 obtains the URI of the manipulated content. This URI is also obtained from the content server 32.

Thus, if the user does not satisfy the age requirement, the blurred content is transmitted to the user terminal apparatus 13 of that user and is displayed thereon. Consequently, children are prevented from being exposed to improper images such as violence scenes, for example.

It should be noted that, if there is any user not satisfying the age requirement, the blurred content is transmitted to the output apparatus 12 of the host apparatus 11. In contrast, if there is no user not satisfying the age requirement, the unblurred content is transmitted to the output apparatus 12 of the host apparatus 11.

Here, the output content change processing executed by the host apparatus 11 ends.

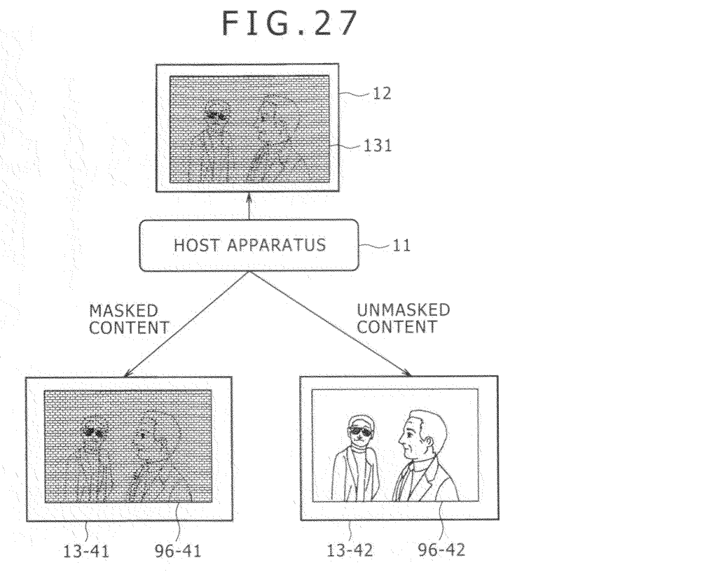

Referring to FIG. 27, there is shown an image that is obtained when output content is changed on the basis of the age requirement as described with reference to FIG. 26.

If the user of the user terminal apparatus 13-41 does not satisfy the age requirement for displaying content, then the processing of step S464 is executed to display the blurred content on the output apparatus 96-41 of the user terminal apparatus 13-41. Namely, the content being displayed on the output apparatus 12 is displayed on the output apparatus 96-41.

If the user of the user terminal apparatus 13-42 satisfies the age requirement for displaying content, the processing of step S463 is executed to display the unblurred content on the output apparatus 96-42 of the user terminal apparatus 13-42.

### [Content Change (3)]

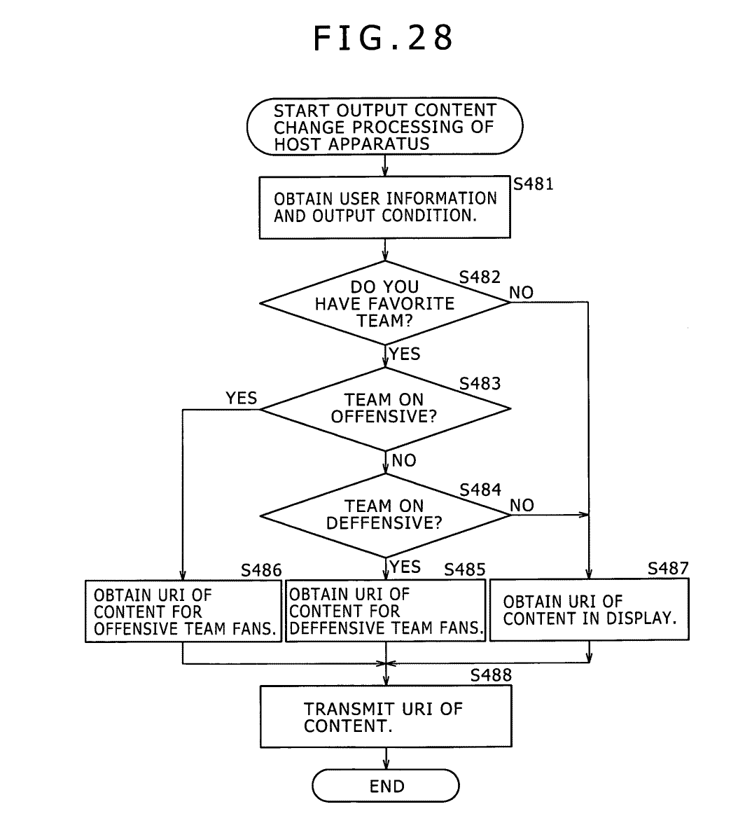

The following describes other processing of changing output content with reference to the flowchart shown in FIG. 28.

FIG. 28 is the flowchart indicative of the output content change processing to be executed by the host apparatus 11. In this embodiment, the content of baseball live coverage is being displayed on the output apparatus 12 and the content to be displayed is changed in accordance with the preference of the user of each user terminal apparatus 13.

It should be noted that the content server 32 of the host apparatus 11 prepares two or more pieces of content manipulated in accordance with user preference before starting a slide show. In addition, the user terminal apparatus 13 is in a login state.

In step S481, the acquisition block 54 obtains user information and an output condition. The user information is obtained from the storage apparatus 34 and the output condition included in content related information is obtained from the content server 32.

The user information includes user favorite baseball teams and the like.

In step S482, the decision block 55 determines on the user information whether there is a user favorite team.

If a user favorite team is found, then the decision block 55 determines in step S483 whether the user favorite team is on the offensive. Namely, the decision block 55 determines whether the team on the offensive in the currently displayed baseball image is the user favorite team.

If the user favorite team is not on the offensive, then the decision block 55 determines in step S484 whether the user favorite team is on the defensive.

If the user favorite team is not found in step S482 and if the user favorite team is found not on the defensive in step S484, namely, if the user favorite team is neither on the offensive nor on the defensive, then the acquisition block 54 obtains the URI of the content in display in step S487. In step S488, the cooperative application 53 transmits the obtained content URI. The user terminal apparatus 13 obtains the image of the received URI to display the image on the output apparatus 96. Consequently, the user can view the image displayed on the output apparatus 12.

If the user favorite team is found to be on the offensive in step S483, then the acquisition block 54 obtains the URI of the content for fans of the offensive team in step S486. In step S488, the cooperative application 53 transmits the obtained URI of the content. Namely, the obtained content URI is transmitted to the user terminal apparatus 13 via the transmitter/receiver 33. The user terminal apparatus 13 obtains the image of the received content URI to display the image on the output apparatus 96. Consequently, the user can view the image of the favorite team that is different from the image displayed on the output apparatus 12.

On the other hand, if the user favorite team is found to be on the defensive in step S484, then the acquisition block 54 obtains the URI of the content for fans of the defensive team in step S485. In step S488, the cooperative application 53 transmits the obtained content URI. Namely, the obtained content URI is transmitted to the user terminal apparatus 13 via the transmitter/receiver 33. The user terminal apparatus 13 obtains the image of the received content URI to display the image on the output apparatus 96. Consequently, the user can view the image of the user favorite team that is different from the image displayed on the output apparatus 12.

Here, the output content change processing executed by the host apparatus 11 ends.

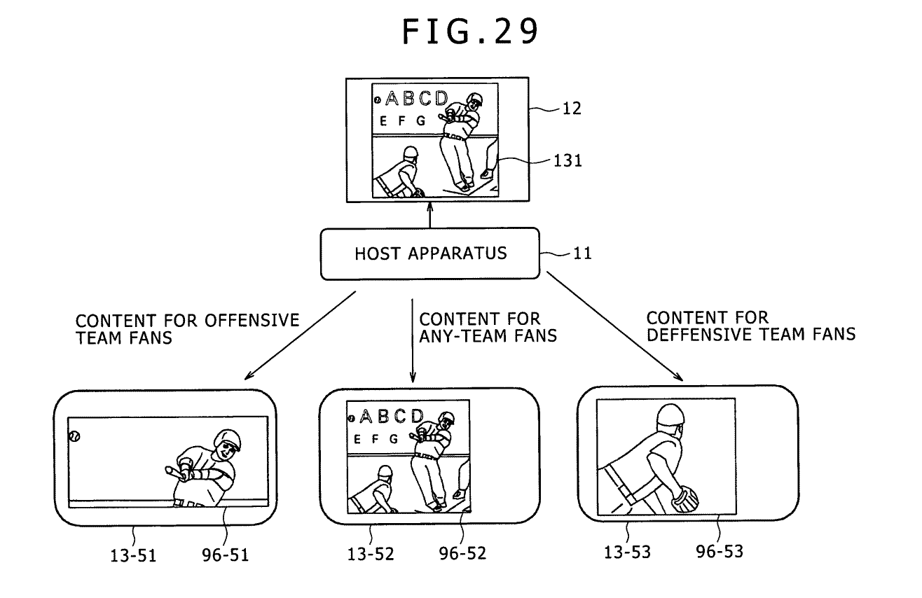

Referring to FIG. 29, there is shown an example in which output content has been changed on the basis of user preference described with reference to FIG. 28.

The output apparatus 12 is displaying the content in which user preference is not considered.

If the user of the user terminal apparatus 13-51 is a fan of the offensive team, then the content for fans of the offensive team is displayed on the output apparatus 96-51 of the user terminal apparatus 13-51.

If the user of the user terminal apparatus 13-52 does not have a favorite team or the user favorite team is neither on the offensive nor on the defensive, then the content for fans having no particular favorite teams is displayed on the output apparatus 96-52. Namely, in this example, the same content as that displayed on the output apparatus 12 is displayed.

If the user of the user terminal apparatus 13-53 is a fan of the team on the defensive, the content for fans of the defensive team is displayed on the output apparatus 96-53 of the user terminal apparatus 13-53.

### [Configuration of a Computer]

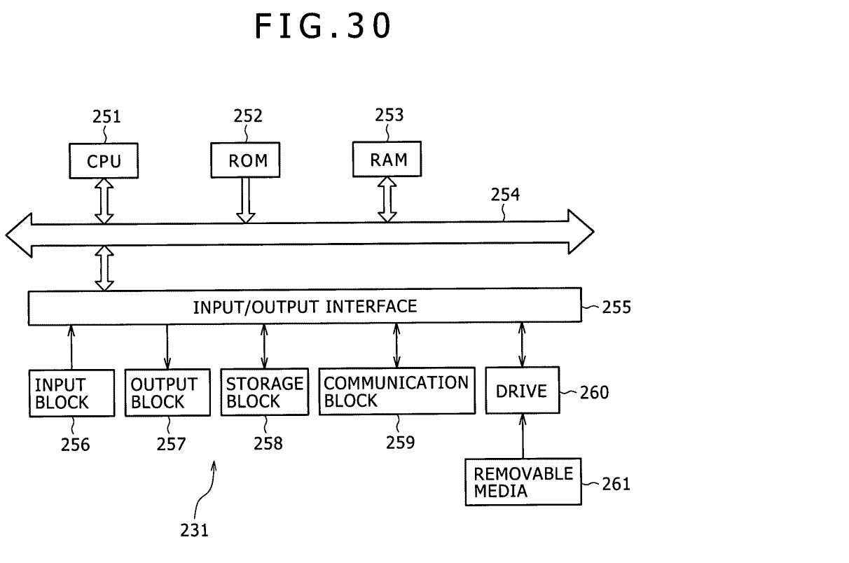

Referring to FIG. 30, there is shown a block diagram illustrating an exemplary hardware configuration of a computer that executes the above-mentioned sequence of processing operations.

In a computer 231, a CPU 251, a ROM (Read Only Memory) 252, and a RAM (Random Access Memory) 253 are interconnected by a bus 254. The bus 254 is further connected with an input/output interface 255. The input/output interface 255 is connected with an input block 256 having a keyboard, a mouse, and a microphone, for example, an output block 257 having an output apparatus and a loudspeaker, for example, and a storage block 258 based on a hard disk drive or a nonvolatile memory, for example. In addition, the input/output interface 255 is connected with a communication block 259 based on a network interface for example and a drive 260 for driving a removable media 261 such as a magnetic disk, an optical disk, a magneto-optical disk, or a semiconductor memory, for example.

In the computer configured as described above, the sequence of processing operations described above are executed when the CPU 251 loads a program from the storage block 258 for example into the RAM 253 via the input/output interface 255 and the bus 254 and executed by the CPU 251. Programs to be executed by the computer 231 (or the CPU 251) are provided as recorded in the removable media 261 that is a magnetic disk (including a flexible disk) for example. The programs are provided as recorded to the removable media 261 that is a package media. It should be noted that the package media is based on an optical disk (CD-ROM (Compact Disc-Read Only Memory) and DVD (Digital Versatile Disc) for example), magneto-optical disk, or a semiconductor memory, for example. Alternatively, the programs are provided through wired or wireless transmission media such as LAN (Local Area Network), the Internet, or digital satellite broadcasting, for example. The programs can be installed in the storage block 258 through the input/output interface 255 by loading the removable media 261 on the drive 260. Also, the programs can be received at the communication block 259 via wired or wireless transmission media and installed in the storage block 258. Further, the programs can be installed in the ROM 252 or the storage block 258 in advance.

It should be noted herein that each of the programs may execute processing operations in a time-dependent manner in the sequence described herein or concurrently or on a demand basis.

The term “system” herein denotes a whole unit configured by a two or more component apparatuses or means.

While preferred embodiments of the present invention have been described using specific terms, such description is for illustrative purpose only, and it is to be understood that changes and variations may be made without departing from the spirit or scope of the following claims.

The present application contains subject matter related to that disclosed in Japanese Priority Patent Application JP 2009-255955 filed in the Japan Patent Office on Nov. 9, 2009, the entire content of which is hereby incorporated by reference.

What is claimed is:

1. An information output apparatus comprising:
storage means for storing an output sequence of content;
output control means for controlling output of said content; and
acquisition means for obtaining output information of said content to be added, wherein
said acquisition means obtains said content and an output condition as said output information of said content to be added from a terminal apparatus,
said storage means stores said sequence of said content to be added, and
said output control means outputs said content to be added in the stored sequence in accordance with said output condition.

2. The information output apparatus according to claim 1, wherein
said output condition includes an output priority of said content; and
said output control means preferentially outputs said prioritized content and, if there is no content to be prioritized, outputs said content in a sequence of storage.

3. The information output apparatus according to claim 2, wherein
said output condition includes a position at which said content is outputted, a size in which said content is outputted, and a time at which said content is outputted.

4. The information output apparatus according to claim 3, wherein
said acquisition means obtains said user information of said terminal apparatus,
said information output apparatus further comprising:
decision means for deciding on the basis of said user information whether said content being outputted is convertible on said terminal apparatus.

5. The information output apparatus according to claim 4, wherein,
when said acquisition means has acquired a request to obtain said content being outputted from said terminal apparatus, if said decision means decides that said content being outputted is convertible on said terminal apparatus,
said acquisition means obtains a uniform resource identifier of said content being outputted,
said information output apparatus further comprising:
transmission means for transmitting said uniform resource identifier of said content being outputted to said terminal apparatus.

6. The information output apparatus according to claim 5, wherein,
if, when a request to obtain said content being outputted has been acquired from said terminal apparatus by said acquisition means, said content being outputted is found by said decision means to be inconvertible on said terminal apparatus,
said acquisition means obtains said uniform resource identifier of said content being outputted and installer information of a codec of said content being outputted, and
said transmission means transmits said uniform resource identifier and said installer information to said terminal apparatus.

7. The information output apparatus according to claim 6, wherein
said acquisition means further obtains information related with said content and, on the basis of said user information of said terminal apparatus and said information related with said content, obtains said content that is different for each of said terminal apparatus, and
said transmission means transmits said content acquired by said acquisition means that is different for each of said terminal apparatus to said each of said terminal apparatus.

8. The information output apparatus according to claim 7, wherein
said acquisition means obtains information of said content that a user intends to obtain from said terminal apparatus, and
said transmission means transmits said content that said user intends to obtain that is different from said content with output thereof controlled by said output control means to said terminal apparatus.

9. The information output apparatus according to claim 8, wherein
said transmission means transmits said content to said terminal apparatus so as to satisfy said output condition.

10. The information output apparatus according to claim 4, wherein,
if, when a request to obtain said content being outputted has been acquired from said terminal apparatus by said acquisition means, said content being outputted is found by said decision means to be inconvertible on said terminal apparatus,
said acquisition means obtains a codec for converting said content being outputted, and
said codec converts said content being outputted,
said information output apparatus further including:
transmission means for transmitting the converted content to said terminal apparatus.

11. An information output method for an information output apparatus including storage means for storing an output sequence of content, output control means for controlling output of said content, and acquisition means for obtaining output information of said content to be added, said information output method including the steps of:
obtaining said content and an output condition as said output information of said content to be added from a terminal apparatus;
storing said sequence of said content to be added in said storage means; and
outputting said content to be added in the stored sequence in accordance with said output condition.

12. A program for making a computer function as storage means for storing an output sequence of content, output control means for controlling output of said content, and acquisition means for obtaining output information of said content to be added, said program including the steps of:
obtaining said content and an output condition as said output information of said content to be added from a terminal apparatus;
storing said sequence of said content to be added in said storage means; and
outputting said content to be added in the stored sequence in accordance with said output condition.

13. An information output apparatus comprising:
a storage configured to store an output sequence of content;
an output controller configured to control output of said content; and
an acquirer configured to obtain output information of said content to be added, wherein
said acquirer obtains said content and an output condition as said output information of said content to be added from a terminal apparatus,
said storage stores said sequence of said content to be added, and
said output controller outputs said content to be added in the stored sequence in accordance with said output condition.
